(19) United States
(12) Patent Application Publication
(10) Pub. No.: US 2025/0251911 A1
(43) Pub. Date: Aug. 7, 2025

(54) SYSTEMS AND METHODS FOR POST-MULTIPLICATION ALIGNMENT FOR FLOATING POINT COMPUTING-IN-MEMORY (CIM)

(71) Applicant: Taiwan Semiconductor Manufacturing Company Ltd., Hsinchu (TW)

(72) Inventor: Yu-Der CHIH, Hsinchu (TW)

(73) Assignee: Taiwan Semiconductor Manufacturing Company Ltd., Hsinchu (TW)

(21) Appl. No.: 18/672,198

(22) Filed: May 23, 2024

Related U.S. Application Data
(60) Provisional application No. 63/550,822, filed on Feb. 7, 2024.

(51) Int. Cl. G06F 7/556; G06F 5/01; G06F 7/501

(52) U.S. Cl. CPC G06F 7/556; G06F 5/01; G06F 7/501

(57) ABSTRACT

A computing-in-memory circuit (CIM) circuit includes an input circuit to receive N first inputs and N second inputs; N summing circuits, each configured to combine the corresponding first exponent and the corresponding second exponent of a corresponding one of the N input pairs to generate a corresponding one of N exponent sums; a first selector circuit configured to select a largest exponent sum; a phasing circuit configured to divide at least a portion of the N exponent sums into N phases from the largest exponent sum, each of the N phases associated with a respective one of N exponent subsets; and N subtractor circuits, each configured to calculate a corresponding one of N exponent differences for each of the N phases, each of the N exponent differences equal to a difference between a corresponding one of the N exponent sums from the respective exponent subset and the largest exponent sum.

### CROSS-REFERENCE TO RELATED APPLICATION

This application claims priority to and the benefit of U.S. Provisional Application No. 63/550,822, filed Feb. 7, 2024, entitled “A NEW POST-MULTIPLICATION ALIGNMENT FOR FLOATING POINT CIM,” which is incorporated herein by reference in its entirety for all purposes.

### BACKGROUND

Computer artificial intelligence (AI) has been built on machine learning, for example, using deep learning techniques. With machine learning, a computing system organized as a neural network computes a statistical likelihood of a match of input data with prior computed data. A neural network refers to a number of interconnected processing nodes that enable the analysis of data to compare an input to “trained” data. Trained data refers to computational analysis of properties of known data to develop models to use to compare input data. An example of an application of AI and data training is found in object recognition, where a system analyzes the properties of many (e.g., thousands or more) of images to determine patterns that can be used to perform statistical analysis to identify an input object.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram of a data computation circuit for performing a multiplication and accumulation (MAC) operations on floating point numbers with post-multiplication alignment, in accordance with some embodiments.

FIG. 2 illustrates a flow chart of an example process of performing the MAC operation executed by the circuit of FIG. 1, in accordance with some embodiments.

FIG. 3 illustrates a flow chart of an example process of selecting a method for dividing exponent sums into a number of phases for the MAC operation of FIG. 2, in accordance with some embodiments.

FIG. 4 illustrates a flow chart of an example process of adjusting a step size for the MAC operation of FIG. 2, in accordance with some embodiments.

FIG. 5 is a graph of an example distribution and grouping of the exponent sums using a first phasing method (e.g., method I) executed by the circuit of FIG. 1, in accordance with some embodiments.

FIG. 6 illustrates a flow chart of an example process of performing the MAC operation using the first phasing method executed by the circuit of FIG. 1, in accordance with some embodiments.

FIG. 7 illustrates a flow chart of an example process of performing the MAC operation using the first phasing method with local maximum executed by the circuit of FIG. 1, in accordance with some embodiments.

FIG. 8 is a graph of an example distribution and grouping of the exponent sums using a second phasing method (e.g., method II) executed by the circuit of FIG. 1, in accordance with some embodiments.

FIG. 9 illustrates a flow chart of an example process of performing the MAC operation using the second phasing method executed by the circuit of FIG. 1, in accordance with some embodiments.

FIG. 10 illustrates a flow chart of an example process of performing the MAC operation using the second phasing method with local maximum executed by the circuit of FIG. 1, in accordance with some embodiments.

FIG. 11 illustrates a flow chart of an example process of performing the MAC operation using a number of devices for the number of phases executed by the circuit of FIG. 1, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Neural networks compute “weights” to perform computation on new data (an input data “word”). Neural networks use multiple layers of computational nodes, where deeper layers perform computations based on results of computations performed by higher layers. Machine learning currently relies on the computation of dot-products and absolute difference of vectors, typically computed with multiply-accumulate (MAC) operations performed on the parameters, input data and weights. The computation of large and deep neural networks typically involves so many data elements, and thus it is not practical to store them in processor cache. Accordingly, these data elements are usually stored in a memory.

Thus, machine learning is very computationally intensive with the computation and comparison of many different data elements. The computation of operations within a processor is orders of magnitude faster than the transfer of data elements between the processor and main memory resources. Placing all the data elements closer to the processor in caches is prohibitively expensive for the great majority of practical systems due to the memory sizes needed to store the data elements. Thus, the transfer of data elements becomes a major bottleneck for AI computations. As the data sets increase, the time and power/energy a computing system uses for moving data elements around can end up being multiples of the time and power used to actually perform computations.

In this regard, computing-in-memory (CIM) circuits have been proposed to perform such MAC operations. A CIM circuit conducts data processing in situ within a suitable memory circuit. The CIM circuit suppresses the latency for data/program fetch and output results upload in corresponding memory (e.g. a memory array), thus solving the memory (or von Neumann) bottleneck of conventional computers. Another key advantage of the CIM circuit is the high computing parallelism, thanks to the specific architecture of the memory array, where computation can take place along several current paths at the same time. The CIM circuit also benefits from the high density of multiple memory arrays with computational devices, which generally feature excellent scalability and the capability of 3D integration. As a non-limiting example, the CIM circuit targeted for various machine learning applications can perform the MAC operations locally within the memory (i.e., without having to send data elements to a host processor) to enable higher throughput dot-product of neuron activation and weight matrices, while still providing higher performance and lower energy compared to computation by the host processor.

The data elements, processed by the CIM circuit, have various types or forms, such as integers number and floating point numbers. A floating point number is typically represented by a sign portion, an exponent portion, and a significand (mantissa) portion that consists of the significant digits of the number. For example, a floating point number format specified by the Institute of Electrical and Electronics Engineers (IEEE®) is thirty-two bits in size and includes twenty-three mantissa bits, eight exponent bits, and one sign bit. Another floating point number format is sixteen bits in size, which includes ten mantissa bits, five exponent bits, and one sign bit.

In machine learning applications, the CIM circuit is frequently configured to process dot product multiplications based on performing MAC operations on a large number of data elements (e.g., an input word vector and a weight matrix), which may each be in the form of floating point numbers, and then process addition (or accumulation) of such dot products. Multiplication of each floating point number pair, generally, includes addition of respective exponent portions (generating an exponent sum) and multiplication of respective mantissa portions (generating a mantissa product). Further, the exponent sum of each floating point number pair is compared to a maximum exponent sum among the plural floating point number pairs to generate an exponent difference. Such exponent differences are utilized to align the exponent portions of the different floating point number pairs, so as to shift the corresponding mantissa products. The shifted mantissa products are summed, with an exponent of the maximum exponent sum, to reach the final sum.

With such an approach, floating point numbers (in MAC operation) may be aligned to the maximum exponent sum, e.g., for a shift and accumulation operation, without consideration of the exponent sum range. For instance, in certain scenarios, the maximum exponent sum may be significantly greater than other exponent sums, potentially resulting in reduced accuracy because certain shifted mantissa products that correspond to the relatively small exponent sums may be truncated or shortened when shifting based on the maximum exponent sum. In such cases, and in the effort of potentially increasing accuracy, certain systems may reserve additional bits for accumulation purposes, which may increase power and resource (e.g., memory space) consumption. As such, shifting/aligning the mantissa products to the maximum exponent sum may at least reduce the accuracy of the MAC operation because of the truncated mantissa products, or increase power consumption and computation resources when reserving additional bits for accumulating the shifted mantissa products.

The present disclosure provides various embodiments of a compute-in-memory (CIM) circuit that can divide/phase/group the floating point numbers into a number of phases for post-multiplication alignment. Post-multiplication can refer to an operation after multiplying the floating point numbers (e.g., multiplying one or more pairs of mantissas). The disclosed CIM circuit can include a feature or a component for detecting a range of exponent sums. The disclosed CIM circuit can determine to divide the floating point numbers into multiple phases for the MAC operation based on the exponent sum range. Dividing the floating point numbers can include grouping the mantissa products and/or the exponent sums associated with respective pairs of floating point numbers into the multiple phases.

In one aspect, the disclosed CIM circuit can divide all the floating point numbers (or pairs of floating point numbers) (e.g., the entire exponent sum range and the corresponding mantissa products) into a number of phases based on the exponent sum range. In another aspect, the disclosed CIM circuit can divide a portion of the floating point numbers into a number of phases and ignore or discard the remaining portion of the floating point numbers (e.g., a portion of the exponent sum range and the corresponding mantissa products outside a desired range from the maximum exponent sum). The disclosed CIM circuit can align or shift the mantissa products according to the maximum exponent sum or a respective local maximum of the exponent sums for each of the phases at a respective time period. The disclosed CIM circuit can sum or combine the shifted mantissa products in each of the phases and accumulate the sums of the mantissa products to output a (final) result of the MAC operation, for example. By phasing the floating point numbers to shift and accumulate the mantissa products as discussed herein, the systems and methods of the technical solution can reduce computation resources, minimize power consumption, and increase the accuracy of the MAC operation for floating point numbers.

Although the various operations, aspects, or features performed by the CIM circuit herein can be described for post-multiplication, it should be noted that similar operations can be performed for pre-multiplication quantization, e.g., phasing the floating point numbers before multiplying the floating point numbers. The features or operations of the technical solution discussed herein can be applied to or performed for CIM application and/or in/near-memory computing (NMC) application, among others.

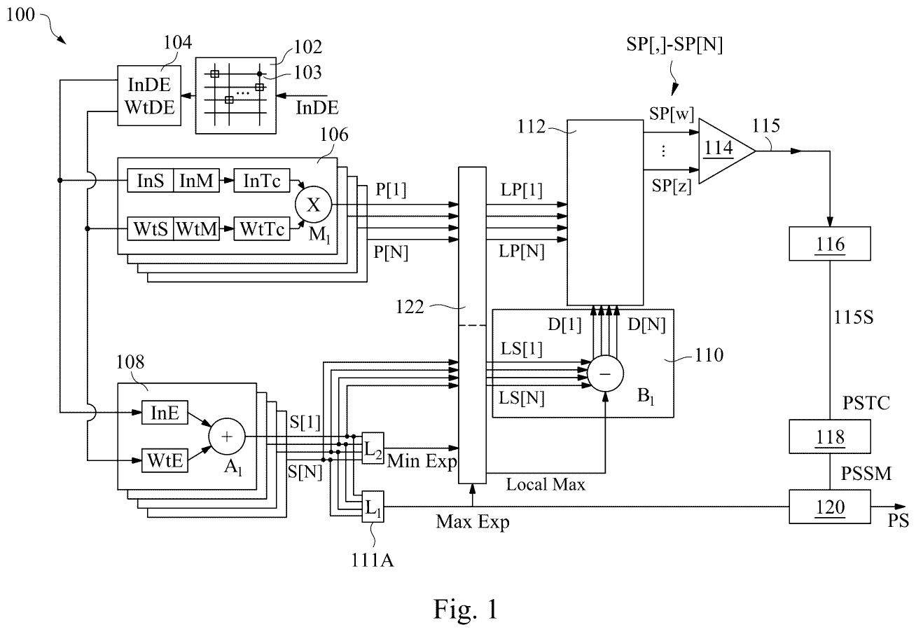

FIG. 1 illustrates a block diagram of a data computation circuit 100, in accordance with some embodiments of the present disclosure. In the illustrated embodiment depicted in FIG. 1, the data computation circuit 100, also referred to as (e.g., CIM) circuit 100 or memory circuit 100, includes various components collectively configured to perform in-memory computations (e.g., multiply-accumulate (MAC) operations) on an input word vector and a weight matrix. The input word vector can include a plural number (N) of input data elements InDE, and the weight matrix can include a plural number (Nd) of weight data elements WtDE. In various embodiments, each of the input data elements InDE and the weight data elements WtDE may include a floating point number. The circuit 100 can perform the in-memory computations with post-multiplication alignment.

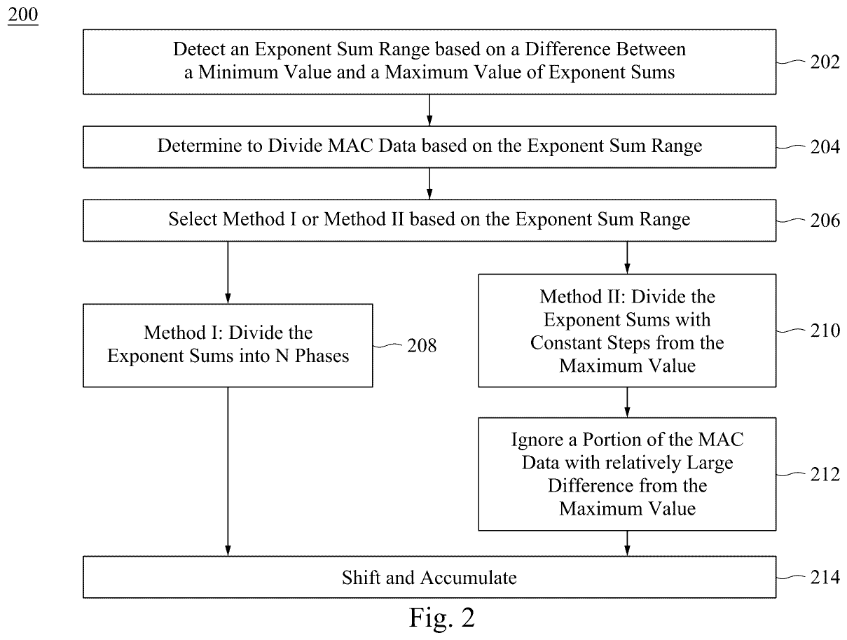

As shown, the circuit 100 includes a memory circuit 102, an input circuit 104, a number of multiplier circuits 106, a number of summing circuits 108, a difference circuit 110 (e.g., sometimes referred to as a subtractor circuit 110), one or more selector circuits 111A-B (e.g., sometimes referred to as selector circuit(s) 111), a shifting circuit 112, an adder circuit (or adder tree) 114, an adder circuit (or adder tree) 116 (e.g., sometimes referred to as an accumulator or aggregation circuit), a first converter 118, a second converter 120, and a phasing circuit 122 (e.g., sometimes referred to as a grouping, dividing, or portioning circuit 122). In some embodiments, the number of multiplier circuits 106 may correspond to the number of summing circuits 108. For example, the circuit 100 may include N (the number of weight/input data elements WtDE/InDE) multiplier circuits 106, and N (the number of weight/input data elements WtDE/InDE) summing circuits 108. In some implementations, the circuit 100 may include a number of shifting circuits 112, a number of adder circuits 114, and/or a number of phasing circuits 122, among others. It should be appreciated that the block diagram of the circuit 100 depicted in FIG. 1 is simplified, and thus, the circuit 100 can include any of various other components while remaining within the scope of the present disclosure. It should be noted that the block diagram of the circuit 100 depicted in FIG. 1 may include more or fewer components, or may include other components not limited to those shown herein, to perform the MAC operation for floating point numbers with post-multiplication alignment, such as described in conjunction with but not limited to at least one of FIGS. 2-11.

The memory circuit 102 may include one or more memory arrays and one or more corresponding circuits. The memory arrays are each a storage device including a number of storage elements 103, each of the storage elements 103 including an electrical, electromechanical, electromagnetic, or other device configured to store one or more data elements, each data element including one or more data bits represented by logical states. In some embodiments, a logical state corresponds to a voltage level of an electrical charge stored in a portion or all of a storage element 103. In some embodiments, a logical state corresponds to a physical property, e.g., a resistance or magnetic orientation, of a portion or all of a storage element 103.

In some embodiments, the storage element 103 includes one or more static random-access memory (SRAM) cells. In various embodiments, an SRAM cell includes a number of transistors, e.g., a five-transistor (5T) SRAM cell, a six-transistor (6T) SRAM cell, an eight-transistor (8T) SRAM cell, a nine-transistor (9T) SRAM cell, etc. In some embodiments, an SRAM cell includes a multi-track SRAM cell. In some embodiments, an SRAM cell includes a length at least two times greater than a width.

In some embodiments, the storage element 103 includes one or more dynamic random-access memory (DRAM) cells, resistive random-access memory (RRAM) cells, magnetoresistive random-access memory (MRAM) cells, ferroelectric random-access memory (FeRAM) cells, NOR flash cells, NAND flash cells, conductive-bridging random-access memory (CBRAM) cells, data registers, non-volatile memory (NVM) cells, 3D NVM cells, or other memory cell types capable of storing bit data.

In addition to the memory array(s), the memory circuit 102 can include a number of circuits to access or otherwise control the memory arrays. For example, the memory circuit 102 may include a number of (e.g., word line) drivers operatively coupled to the memory arrays. The drivers can apply signals (e.g., voltages) to the corresponding storage elements 103 so as to allow those storage elements 103 to be accessed (e.g., programmed, read, etc.). For another example, the memory circuit 102 may include a number of programming circuits and/or read circuits that are operatively coupled to the memory arrays.

The memory arrays of the memory circuit 102 are each configured to store a number of the weight data elements WtDE. In some embodiments, the programming circuits may write the weight data elements WtDE into corresponding storage elements 103 of the memory arrays, respectively, while the reading circuit may read bits written into the storage elements 103, so as to verify or otherwise test whether the written weight data elements WtDE are correct. The drivers of the memory circuit 102 can include or be operatively coupled to a number of input activation latches that are configured to receive and temporarily store the input data elements InDE. In some other embodiments, such input activation latches may be part of the input circuit 104, which can further include a number of buffers that are configured to temporarily store the weight data elements WtDE retrieved from the memory arrays of the memory circuit 102. As such, the input circuit 104 can receive the input data elements InDE and the weight data elements WtDE.

In various embodiments of the present disclosure, the input word vector (including, e.g., the input data elements InDE) and the weight matrix (including, e.g., the weight data elements WtDE), on which the circuit 100 is configured to perform MAC operations, each include a number of floating point numbers. As such, each of the data elements InDE and weight data elements WtDE includes a sign bit, a plural number of exponent bits, and a plural number of mantissa bits (sometimes referred to as fraction bits).

For example, each of the data elements InDE and weight data elements WtDE has a BF16 format, also referred to as a bfloat format or brain floating-point format in some embodiments, in which a first bit represents a sign of a floating-point number, a subsequent eight bits represent an exponent of the floating-point number, and the final seven bits represent the mantissa, or fraction, of the floating-point number. Because the mantissa is configured to start with a non-zero value, the final seven bits of each stored data element represent an eight-bit mantissa having a first, most significant bit (MSB) equal to one.

In some embodiments, each of the data elements InDE and the weight data elements WtDE has a FP16 format, also referred to as a half precision format, in which a first bit represents a sign of a floating-point number, a subsequent five bits represent an exponent of the floating-point number, and the final ten bits represent the mantissa, or fraction, of the floating-point number. In this case, the final ten bits of each stored data element represent an eleven-bit mantissa having a first MSB equal to one. In some other embodiments, each of the data elements InDE and the weight data elements WtDE has a floating-point format other than a BF16 or FP16 format, e.g., another 16-bit format, a 32-bit, 64-bit, 128-bit, or 256-bit format, or a 40-bit or 80-bit extended precision format. The sign and mantissa of a data element representing a floating-point number are collectively referred to as a signed mantissa of the floating-point number. The MSB of a mantissa is referred to as a hidden bit or hidden MSB.

Referring still to FIG. 1, the input circuit 104 is configured to output entireties of each data element of data elements InDE and WtDE to each of the multiplier circuits 106 and the summing circuits 108. In some embodiments, the input circuit 104 is configured to output the signed mantissa of each data element to the multiplier circuit 106 and the exponent of each data element to the summing circuit 108, which will be described as follows.

The multiplier circuits 106 are each an electronic circuit, e.g., an integrated circuit (IC), configured to receive, e.g., from the input circuit 104, a sign bit InS and a mantissa InM (collectively a signed mantissa InS/InM) of each of the N data elements InDE, and a sign bit WtS and a mantissa WtM (collectively a signed mantissa WtS/WtM) of each of the N data elements WtDE. The summing circuits 108 are each an electronic circuit, e.g., an IC, configured to receive, e.g., from the input circuit 104, an exponent InE of each of the N data elements InDE, and an exponent WtE of each of the N data elements WtDE.

The multiplier circuits 106 may each include one or more data registers (not shown) configured to receive the instances of signed mantissas InS/InM and WtS/WtM. In the embodiment depicted in FIG. 1, the multiplier circuit 106 is configured to receive the instances of signed mantissas InS/InM and WtS/WtM corresponding to data elements InDE and WtDE. In some other embodiments, the multiplier circuit 106 includes the one or more data registers configured to receive the instances of signed mantissas InS/InM and/or WtS/WtM including the hidden MSBs. In some embodiments, the multiplier circuit 106 includes the one or more data registers configured to add the hidden MSBs to the received instances of signed mantissas InS/InM and/or WtS/WtM.

The multiplier circuit 106 may include logic circuitry (not shown) configured to, in operation, reformat each instance of signed mantissa InS/InM to a two's complement mantissa InTC, also referred to as reformatted mantissa InTC, and to reformat each instance of signed mantissa WtS/WtM to a two's complement mantissa WtTC, also referred to as reformatted mantissa WtTC. Reformatted mantissa InTC has a same number of bits as signed mantissa InS/InM, and reformatted mantissa WtTC has a same number of bits as signed mantissa WtS/WtM.

The multiplier circuit 106 may include one or more logic gates M1 configured to, in operation, multiply some or all of the instances of reformatted mantissas InTC with some or all of the instances of reformatted mantissas WtTC, thereby generating N products, e.g., P[1] to P[N]. In various embodiments, the one or more logic gates M1 include one or more AND or NOR gates or other circuits suitable for performing some or all of a multiplication operation. The one or more logic gates M1 are configured to, in operation, generate each of the products P[1] to P[N] as a two's complement data element including a number of bits equal to twice the number of bits of reformatted mantissas InTC and WtTC minus one. The one or more logic gates M1 may be referred to as a multiplier configured to multiply some or all of the instances of reformatted mantissas InTC with some or all of the instances of reformatted mantissas WtTC. In some cases, the multiplier (e.g., the one or more logic gates M1) can receive the signed mantissa InS/InM or the signed mantissa WtS/WtM for the multiplication.

The multiplier circuits 106 are configured to, in operation, generate the number N of products P[1] to P[N]. For example, the multiplier circuits 106 can generate the number N of products P[1]-P[N] equal to sixteen. In some other embodiments, the multiplier circuits 106 can generate the number N of products P[1]-P[N] fewer or greater than sixteen, such as according to the floating-point format.

In some embodiments, e.g., those in which data elements InDE and WtDE have the BF16 format, the multiplier circuit 106 is configured to generate each of the products P[1]-P[N] having a total of 17 bits based on each of signed mantissas InS/InM and WtS/WtM and reformatted mantissas InTC and WtTC having a total of nine bits. In some embodiments, e.g., those in which data elements InDE and WtDE have the FP16 format, the multiplier circuit 106 is configured to generate each of products P[1]-P[N] having a total of 23 bits based on each of signed mantissas InS/InM and WtS/WtM and reformatted mantissas InTC and WtTC having a total of 12 bits. Embodiments in which the multiplier circuit 106 is configured to generate each of products P[1]-P[N] having other total bit numbers based on each of signed mantissas InS/InM and WtS/WtM and reformatted mantissas InTC and WtTC having other total bit numbers are within the scope of the present disclosure.

The multiplier circuit 106 is thereby configured to, in operation, perform multiplication and reformatting operations on sign and mantissa bits of input data elements InDE and weight data elements WtDE so as to generate two's complement products P[1]-P[N]. The multiplier circuit 106 is configured to output products P[1]-P[N] to one or more circuits or components of the circuit 100, such as the phasing circuit 122 and/or the shifting circuit 112 on a data bus (not shown).

The summing circuits 108 each include one or more data registers (not shown) configured to receive the instances of exponents InE and WtE corresponding to the number of data elements of data elements InDE and WtDE discussed above with respect to the multiplier circuit 106. The summing circuits 108 each include one or more logic gates A1 configured to, in operation, add each instance of exponent InE to each instance of exponent WtE. In various embodiments, the one or more logic gates A1 include one or more full adder gates, half adder gates, ripple-carry adder circuits, carry-save adder circuits, carry-select adder circuits, carry-look-ahead adder circuits, or other circuits suitable for performing some or all of an addition operation. The respective logic gates A1 of the summing circuits 108 are configured to generate exponent sums S[1]-S[N] as data elements having a total number of bits equal to the number of bits of each of exponents InE and WtE plus one.

The summing circuits 108 are configured to, in operation, generate the exponent sums S[1]-S[N] having the total number N and an ordering of data elements corresponding to the total number N and ordering of the data elements of the products P[1]-P[N] discussed above with respect to the multiplier circuit 106. The sorting or arrangement of the exponent sums S[1]-S[N] can be similar to the products P[1]-P[N]. Accordingly, for a total of N combinations of data elements InDE and WtDE, each nth combination corresponds to both the nth exponent sum S[n] of the exponent sums S[1]-S[N] and the nth product P[n] of the products P[1]-P[N].

In some embodiments, e.g., those in which the data elements InDE and WtDE have the BF16 format, the summing circuit 108 is configured to generate each corresponding one of the exponent sums S[1]-S[N] having a total of nine bits based on each of the exponents InE and WtE having a total of eight bits. In some embodiments, e.g., those in which the data elements InDE and WtDE have the FP16 format, the summing circuit 108 is configured to generate each of the sums S[1]-S[N] having a total of six bits based on each of exponents InE and WtE having a total of five bits. The summing circuit 108 being configured to generate each of the exponent sums S[1]-S[N] having other total bit numbers based on each of exponents InE and WtE having other total bit numbers is within the scope of the present disclosure. The summing circuits 108 are configured to output the exponent sums S[1]-S[N] to other components of the circuit 100 including at least one of the selector circuit(s) 111, the phasing circuit 122, or the difference circuit 110 on a data bus (not shown).

The selector circuit 111 (e.g., 111A and/or 111B) is an electronic circuit, e.g., an IC, including or corresponding to one or more logic gates (e.g., L1 and/or L2) configured to receive the exponent sums S[1]-S[N] from the summing circuits 108. In some cases, the circuit 100 may include one selector circuit 111, e.g., including a first selector circuit 111A without a second selector circuit 111B. In some other cases, the circuit 100 may include multiple selector circuits 111, e.g., including the first selector circuit 111A and the second selector circuit 111B. For purposes of providing examples herein, the circuit 100 can include the first selector circuit 111A (e.g., sometimes referred to generally as selector circuit 111A) and the second selector circuit 111B (e.g., sometimes referred to generally as selector circuit 111B).

Each of the selector circuits 111A, 111B can include one or more logic gates. For example, the first selector circuit 111A can include one or more logic gates L1. The one or more logic gates L1 are configured to, in operation, generate a maximum exponent sum MaxExp as a data element having a value equal to a maximum value of the data elements of the exponent sums S[1]-S[N] and having a number of bits equal to those of the data elements of the exponent sums S[1]-S[N]. The one or more logic gates L1 can be configured to select the maximum exponent sum MaxExp from the exponent sums S[1]-S[N]. The one or more logic gates L1 are configured to output the maximum exponent sum MaxExp to one or more other circuits or components of the circuit 100, such as but not limited to the phasing circuit 122, the difference circuit 110, and/or the converter circuit 120, as discussed below.

In further examples, the second selector circuit 111B can include one or more logic gates L2. The one or more logic gates L2 are configured to, in operation, generate a minimum exponent sum MinExp as a data element having a value equal to a minimum value of the data elements of the exponent sums S[1]-S[N] and having a number of bits equal to those of the data elements of the exponent sums S[1]-S[N]. The one or more logic gates L2 can be configured to select the minimum exponent sum MinExp from the exponent sums S[1]-S[N]. The one or more logic gates L2 are configured to output the minimum exponent sum MinExp to one or more other circuits or components of the circuit 100, such as but not limited to the phasing circuit 122 and/or the converter circuit 120, as discussed below.

The phasing circuit 122 is an electronic circuit, e.g., an IC, including one or more logic gates or components configured to receive at least one of the exponent sums S[1]-S[N] from the summing circuits 108 and/or the products P[1]-P[N] from the multiplier circuits 106. In some cases, the phasing circuit 122 may include or correspond to multiple circuits electrically coupled to each other for managing the arrangements of the exponent sums S[1]-S[N] and the products P[1]-P[N]. In some implementations, the phasing circuit 122 may sort, rank, or otherwise arrange the exponent sums S[1]-S[N] and the products P[1]-P[N] according to the magnitude of the exponent sums S[1]-S[N]. For example, the phasing circuit 122 can sort or arrange the exponent sums S[1]-S[N] from the highest exponent sum to the lowest exponent sum, or vice versa. The phasing circuit 122 can sort or arrange the products P[1]-P[N] based on the arrangement of the exponent sums S[1]-S[N], such that the products P[1]-P[N] can be shifted or aligned (e.g., by the shifting circuit 112) according to the corresponding exponent sums S[1]-S[N]. In some arrangements, there may be certain exponent sums may be the same as each other. In such cases, the phasing circuit 122 may group similar (or the same) exponent sums S[1]-S[N] together, and sort these groups of exponent sums S[1]-S[N] according to the magnitude of the exponent sum S[n] in each group. For purposes of providing descriptive examples, each of the exponent sums S[1]-S[N] may be different from one another (e.g., non-repeating), although it should be noted that sorting the exponent sums S[1]-S[N] can include sorting groups of exponent sums S[1]-S[N], where each group include a respective exponent sum. The phasing circuit 122 can perform similar grouping or arrangement for the products P[1]-P[N].

The phasing circuit 122 is configured to receive the maximum exponent sum MaxExp from the selector circuit 111A. In some cases, the phasing circuit 122 may be configured to receive the minimum exponent sum MinExp from the selector circuit 111B. The phasing circuit 122 can include one or more logic gates (e.g., a subtractor) configured to determine a difference between the maximum exponent sum MaxExp and the minimum exponent sum MinExp. The phasing circuit 122 can generate an exponent sum range indicative of the difference between the maximum exponent sum MaxExp and the minimum exponent sum MinExp, e.g., the variation between the smallest and largest exponent sums. In some cases, the phasing circuit 122 may add one to the difference between the maximum exponent sum MaxExp and the minimum exponent sum MinExp to generate the exponent sum range, e.g., for purposes of dividing the exponent sums into phases. In some cases, the exponent sum range can represent or indicate a range of exponent sums S[1]-S[N]. The exponent sum range can include a number of bits based on the format, such as a total of nine bits for the BE16 format or a total of six bits for the FP16 format.

The phasing circuit 122 is configured to phase, divide, or otherwise group the exponent sums S[1]-S[N] and/or the products P[1]-P[N] into a number of phases (e.g., N phases). The respective pair of exponent sum S[n] and product P[n] can be in the same phase. In some implementations, the exponent sum range can be an indicator for the phasing circuit 122 to determine whether to divide the exponent sums S[1]-S[N] and/or the products P[1]-P[N] into the N phases. For example, the phasing circuit 122 can compare the exponent sum range to a predetermined threshold. If the exponent sum range is greater than or equal to the predetermined threshold (e.g., indicating that there is a relatively large deviation between the maximum exponent sum MaxExp and the minimum exponent sum MinExp), the phasing circuit 122 can determine to divide at least a portion of the exponent sums S[1]-S[N] and the products P[1]-P[N] into the N phases. The relatively large deviation can be indicative of excessive bit extension, which increases power and resource consumption, or excessive truncating of relatively small mantissa products during the shift operation, which reduces the accuracy of the MAC operation. In this case, the shift and accumulation operation can be performed in multiple phases, each in a respective time period. Hence, dividing the exponent sums S[1]-S[N] and the products P[1]-P[N] into the N phases for a shift and accumulation operation can reduce the power and resource consumption or increase the accuracy of the MAC operation by minimizing the truncating of the mantissa products during the shift operation.

If the exponent sum range is less than the predetermined threshold (e.g., indicating that there is a relatively small or no deviation between the maximum exponent sum MaxExp and the minimum exponent sum MinExp), the phasing circuit 122 can determine to forward the exponent sums S[1]-S[N] to the difference circuit 110 and the products P[1]-P[N] to the shifting circuit 112. In this case, the phasing circuit 122 may not divide the exponent sums S[1]-S[N] and the products P[1]-P[N] into the N phases (e.g., perform the shift and accumulation operation in one phase). In some implementations, the phasing circuit 122 may be configured to divide at least a portion of the exponent sums S[1]-S[N] and at least a portion of the products P[1]-P[N] into the N phases regardless of the exponent sum range (or without comparing the exponent sum range to the predetermined threshold). For purposes of providing examples herein, the phasing circuit 122 is configured to divide the exponent sums S[1]-S[N] and/or the products P[1]-P[N] into the N phases in response to receiving the exponent sums S[1]-S[N] and/or the products P[1]-P[N] (e.g., performing the phasing without comparing the exponent sum range to the predetermined threshold).

For purposes of providing examples herein, dividing the exponent sums S[1]-S[N] into the N phases can be associated with dividing the corresponding products P[1]-P[N] into the N phases, or vice versa. As such, it should be noted the operation of dividing the exponent sums S[1]-S[N] into the N phases can similarly reflect dividing the corresponding products P[1]-P[N] into the N phases, or vice versa. Additionally, it should be noted that each phase of the N phases includes a subset of the exponent sums S[1]-S[N] (e.g., sometimes referred to as an exponent subset or a sum subset of the respective phase) and/or a subset of the products P[1]-P[N] (e.g., sometimes referred to as a mantissa subset or a product subset of the respective phase).

The phasing circuit 122 can divide at least a portion of the exponent sums S[1]-S[N] (and at least a portion of the products P[1]-P[N]) into the N phases using one of at least two methods (e.g., a first phasing method/method I and a second phasing method/method II), as discussed herein. Although two (phasing) methods are discussed herein for purposes of providing examples, it should be noted that other techniques or implementations for dividing the exponent sums S[1]-S[N] (and/or the products P[1]-P[N]) into the N phases can be similarly performed by the phasing circuit 122, not limited to the two methods.

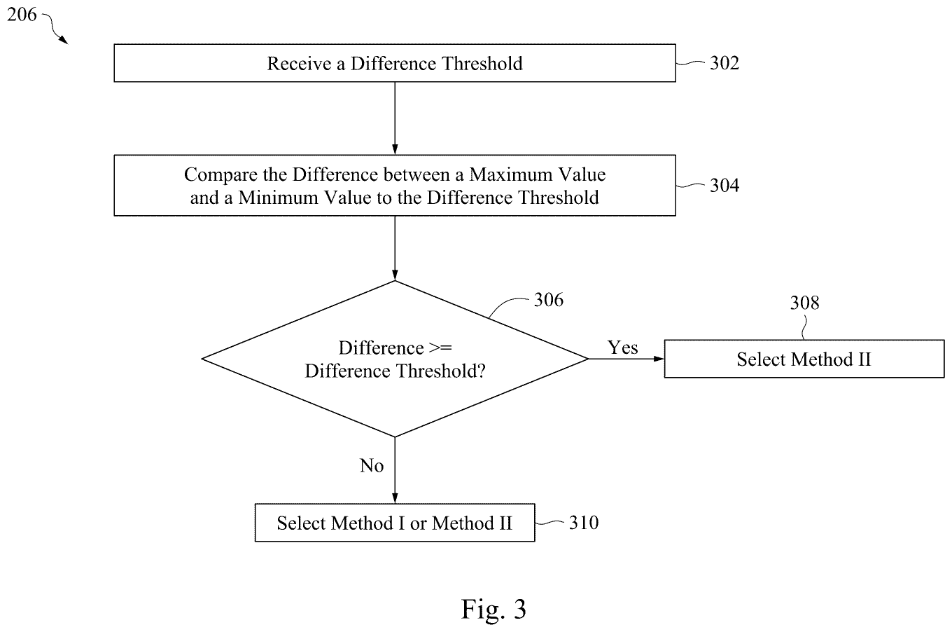

In some configurations, the phasing circuit 122 can determine whether to use the first phasing method or the second phasing method based on the exponent sum range, such as described in conjunction with at least FIG. 3. For example, the phasing circuit 122 can compare the exponent sum range (or the difference between the maximum exponent sum and the minimum exponent sum) to a difference threshold. The difference threshold can include a predetermined value, such as corresponding to a range (or a maximum number) of exponent sums allowed to be grouped into the N phases. The difference threshold can be adjusted based on the configuration of the circuit 100. An exponent sum range being greater than or equal to the threshold can be indicative of a relatively large exponent sum range, where a portion of the exponent sums (e.g., starting from the smallest exponent sum) may have minimal impact on the result of the MAC operation and can be ignored/discarded. The phasing circuit 122 can determine to use the second phasing method based on the exponent sum range (or the difference) being greater than or equal to the difference threshold. Otherwise, the phasing circuit 122 may determine to use either the first phasing method or the second phasing method based on the exponent sum range (or the difference) being less than the difference threshold.

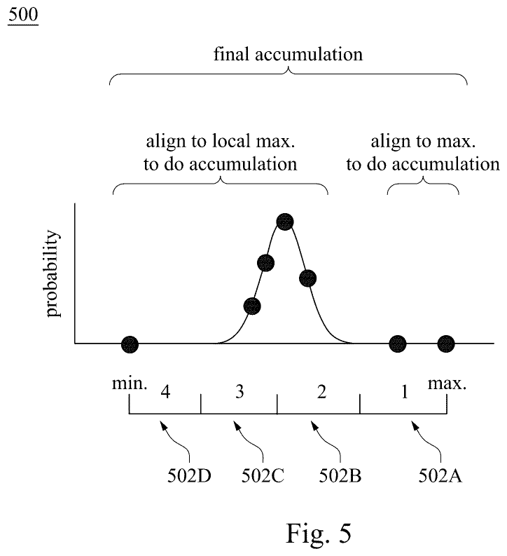

In various implementations, the phasing circuit 122 can divide all of the exponent sums S[1]-S[N] (e.g., the entire range of the exponent sums S[1]-S[N]) into respective N phases using the first phasing method. The features or operations of the first phasing method for dividing the exponent sums S[1]-S[N] (and/or the products P[1]-P[N]) can be described in conjunction with but not limited to at least one of FIG. 5-7 or 11. For example, the phasing circuit 122 can be configured to divide the exponent sums S[1]-S[N] into predefined N phases, e.g., two phases, three phases, four phases, etc. The predefined N phases can be four phases, for purposes of providing examples herein. Using the exponent sum range, the phasing circuit 122 can determine the size of each phase by dividing the exponent sum range by the predefined N phases (e.g., four in this case).

For example, if the exponent sum range is eight (e.g., the range from the highest exponent sum to the lowest exponent sum), the phasing circuit 122 can determine a phase size of two (e.g., eight divided by four). The phasing circuit 122 can start dividing the exponent sums S[1]-S[N] starting from the highest exponent sum to the lowest exponent sum or from the lowest exponent sum to the highest exponent sum. In this case, each of the N phases can include two different exponent sums starting from the highest exponent sum or starting from the lowest exponent sum depending on the configuration of the phasing circuit 122. It should be noted that the value of each exponent sum S[n] discussed herein can be described in decimal format for purposes of simplifying the examples, although the exponent sums S[1]-S[N] are in binary numbers.

In some implementations, depending on the distribution of the exponent sums S[1]-S[N], certain phases may include more or less number of exponent sums. In some cases, depending on the distribution of the exponent sums S[1]-S[N], certain phases may not include or be associated with an exponent sum. For example, if there are four exponent sums (or four groups of exponent sums) including the values of one, two, seven, and eight, the exponent sum range can be from one to eight (e.g., range of eight). In this example, if the phasing circuit 122 is configured to group the four exponent sums into four phases evenly divided across the exponent sum range, a first phase can include exponent sums of seven and eight, a second phase and a third phase may not be associated with any exponent sum, and a fourth phase can include the exponent sums of one and two. As such, each of the N phases may include a different number of exponent sums as part of a respective exponent subset in the respective phase. Similarly, each of the N phases may include a different number of the corresponding products as part of a respective mantissa (product) subset in the respective phase.

In some arrangements, the N phases (e.g., four phases) may not be evenly divided across the exponent sum range. For example, the phasing circuit 122 may determine an exponent sum range of ten, e.g., including an exponent sum of one and an exponent sum of ten. The phasing circuit 122 can determine a phase size of around three by dividing ten by four and rounding up (e.g., to the nearest whole number). In this case, assuming exponent sums ranging from one to ten, the phasing circuit 122 can divide the exponent sums S[1]-S[N] into a first phase associated with a subset of the exponent sum range from eight to ten (e.g., three largest exponent sums, representing the largest phase), a second phase associated with a subset of the exponent sum range from five to seven (e.g., the next three largest exponent sums, representing the second largest phase), a third phase associated with a subset of the exponent sum range from two to four (e.g., the next three largest exponent sums, representing the second smallest phase), and a fourth phase associated with a subset of the exponent sum range including the exponent sum of one (e.g., the remaining exponent sum, representing the smallest phase), for example. As such, each of the N phases may include a different subset size of the exponent sum range. It should be noted that the phasing circuit 122 can divide the exponent sums S[1]-S[N] (and the products P[1]-P[N]) into more or less number of phases, not limited to the number of phases discussed herein.

In some cases, the phasing circuit 122 can use a predefined phase size (e.g., sometimes referred to as a step size or a range size) to divide the exponent sums S[1]-S[N] (and the corresponding products P[1]-P[N]) into the N phases. For example, the phasing circuit 122 can be configured to divide an exponent sum range of 20 using a phase size of three. In such cases, the phasing circuit 122 can divide or distribute at least a portion of the exponent sums S[1]-S[N] into seven phases. It should be noted that the phase size of three is used as an example, and other phase sizes can be used similarly for any exponent sum range.

In some implementations, the phasing circuit 122 can divide the exponent sums S[1]-S[N] into the N phases based on the distribution (or clusters) of the exponent sums S[1]-S[N]. In this case, the number of phases can vary based on the clustering of the exponent sums S[1]-S[N], e.g., the phasing circuit 122 can increase or decrease the size of one or more respective phases. Taking the example of the exponent sum range of eight and including exponent sums of one to two and seven to eight, the phasing circuit 122 can divide the exponent sums of seven to eight into a first phase, and the exponent sums of one to two into a second phase according to the distribution of the exponent sums S[1]-S[N] (e.g., the data points). In another example, for an exponent sum range of ten and including exponent sums of one to two and six to ten, the phasing circuit 122 can divide the exponent sums of nine to ten into a first phase, the exponent sums of six to eight into a second phase, and the exponent sums of one to two into a third phase according to the distribution of the exponent sums S[1]-S[N] and the configuration of the phasing circuit 122.

In further examples, the phasing circuit 122 may divide the exponent sums S[1]-S[N] into each phase of N phases until a predetermined number of data points (e.g., phase size) is satisfied/met. For example, the phase size can be predetermined or set to 10 (among other values). The phasing circuit 122 can group or divide the exponent sums starting from the largest exponent sum into a respective phase until the respective phase includes at least 10 exponent sums. The same (or repeated) exponent sum value can be grouped into the same phase. As such, the number of phases and/or the number of exponent sums in each of the phases can vary or depend on the distribution of the exponent sums S[1]-S[N].

The grouping/phasing/dividing of the entire exponent sum range (and the corresponding products P[1]-P[N] for the exponent sums S[1]-S[N] within the exponent sum range) can be performed as part of the first phasing method. One or more features discussed herein for dividing or phasing the exponent sums S[1]-S[N] and the corresponding products P[1]-P[N] can be performed in combination, additionally, or alternatively to each other.

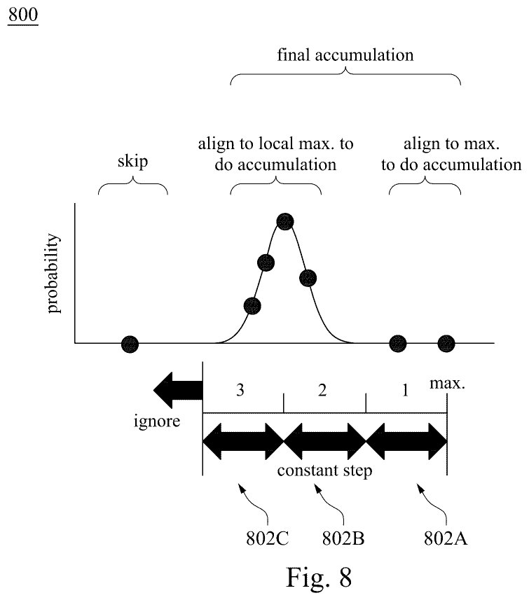

In various implementations, the phasing circuit 122 can divide a portion of the exponent sums S[1]-S[N] (e.g., a portion or subset of the range of exponent sums S[1]-S[N]) into respective N phases using the second phasing method. The second phasing method can include one or more operations or features similar to the first phasing method. The features of the second phasing method can be described in conjunction with but not limited to at least one of FIGS. 8-11.

For example, the phasing circuit 122 can receive or be configured with a step size (e.g., sometimes referred to as a phase size) as part of configuring the phasing circuit 122. The step size can be predetermined or a default value. The phasing circuit 122 can receive or be configured with a predetermined number of constant steps (e.g., N constant steps) used to divide the exponent sum range into corresponding N phases, where the size of each of the N phases can correspond to the step size. To divide the exponent sums S[1]-S[N], the phasing circuit 122 can apply N constant steps having the step size to the exponent sum range starting from the maximum exponent sum, such as shown in at least FIG. 8, for example.

As an example, with an exponent sum range of 20, a step size of five, and a number of constant steps of three, the phasing circuit 122 can divide the exponent sums S[1]-S[N] into three phases associated with the three constant steps starting from the largest exponent sum. In this example, the first phase includes the largest five exponent sums, the second phase includes the second largest five exponent sums continuing from the exponent sums of the first phase, and the third phase includes the third largest five exponent sums continuing from the exponent sums of the second phase. Each of the N phases can include a respective exponent subset, where the exponent subset includes the corresponding five exponent sums in this example. Each of the N phases can include a respective mantissa subset corresponding to the respective exponent subset. The last (smallest) five exponent sums, when utilizing the second phasing method, can be ignored or discarded from the MAC operation because the one or more pairs of exponent sums and products associated with the one or more exponent sums outside the N constant steps or N phases are considered as negligible in magnitude, relatively small, or having a relatively large difference from the maximum exponent sum. By discarding a portion of the exponent sum range outside the N phases, the phasing circuit 122 can improve (reduce) power consumption and resource consumption while maintaining or improving the accuracy of the MAC operation.

In some implementations, certain features of the second phasing method can be applied or performed in conjunction or combination with the features of the first phasing method. For instance, the phasing circuit 122 can use the first phasing method to divide the exponent sums S[1]-S[N] into the N phases. In response to obtaining the N phases using the first phasing method, the phasing circuit 122 can discard or ignore a portion of the exponent sums S[1]-S[N] (and a portion of the corresponding products P[1]-P[N]) within at least a portion of the last phase associated with the smallest exponent sum, as part of the second phasing method. Additionally or alternatively, the phasing circuit 122 can perform other techniques or features for dividing/phasing/grouping the exponent sums S[1]-S[N] and the corresponding products P[1]-P[N], not limited to the phasing methods discussed herein.

The phasing circuit 122 can output the one or more exponent sums of/in each of the N phases to the difference circuit 110 on one or more data buses (not shown). The exponent sums of each phase can be referred to as local sums LS[1]-LS[N] (e.g., representing the one or more exponent sums local to the respective phase). The phasing circuit 122 can output the local sums LS[1]-LS[N] of each phase in a different time period, time frame, or clock cycle from other phases of the N phases. For instance, the phasing circuit 122 can output the local sums LS[1]-LS[N] of the first phase in a first time period, and output the local sums LS[1]-LS[N] of the second phase in a second time period, etc.

The phasing circuit 122 can output the one or more products of/in each of the N phases to the shifting circuit 112 on one or more data buses (not shown). The products of each phase can be referred to as local products LP[1]-LP[N] (e.g., representing the one or more products local to the respective phase). The phasing circuit 122 can output the local products LP[1]-LP[N] of each phase in a different time period. For instance, the phasing circuit 122 can output the local products LP[1]-LP[N] of the first phase in the first time period, and output the local products LP[1]-LP[N] of the second phase in the second time period, etc. In some arrangements, the phasing circuit 122 can output the local products LP[1]-LP[N] in a similar time period as the corresponding local sums LS[1]-LS[N].

In some other arrangements, the phasing circuit 122 may output the local products LP[1]-LP[N] in a different time period (or a different clock cycle or a different time instance) from outputting the corresponding local sums LS[1]-LS[N]. For example, the phasing circuit 122 may output the local sums LS[1]-LS[N] to the difference circuit 110 at a first time instance, and output the local products LP[1]-LP[N] to the shifting circuit 112 at a second time instance after the first time instance. In this example, as described herein, the difference circuit 110 may output exponent sum differences (e.g., D[1]-D[N]) generated based on the corresponding local sums LS[1]-LS[N] to the shifting circuit 112 for shifting/aligning the corresponding local products LP[1]-LP[N] at the second time instance similar to outputting the corresponding local products LP[1]-LP[N], for example. In some other cases, the phasing circuit 122 may output the local products LP[1]-LP[N] at a first time instance and the corresponding local sums LS[1]-LS[N] at a second time instance after the first time instance.

In some configurations, the phasing circuit 122 can include one or more logic gates configured to select a respective largest exponent sum from each of the N phases as a respective local maximum exponent sum (e.g., sometimes referred to generally as a local maximum or LocalMax) of the corresponding phase. The one or more logic gates for selecting the respective largest exponent sum can be similar to the one or more logic gates (e.g., L1 and/or L2) of the selector circuit 111. The phasing circuit 122 can output the local maximum and the local sums LS[1]-LS[N] of the respective phase to the difference circuit 110 at a similar time period. The local maximum for the first phase associated with the maximum exponent sum MaxExp can be the maximum exponent sum MaxExp. In this case, the phasing circuit 122 can forward the maximum exponent sum MaxExp to the difference circuit 110. In some implementations, the phasing circuit 122 may output or forward the maximum exponent sum MaxExp to the difference circuit 110 for each of the N phases. The phasing circuit 122 can output other values or data to other circuits or components of the circuit 100, not limited to the difference circuit 110 or the shifting circuit 112.

It should be noted that the variables or values, such as the number of phases or constant steps, the size of each phase or constant step, the one or more thresholds, the exponent sum range, etc., are not limited to the examples provided herein, and other variables or values can be used similarly by the circuit 100 or other devices or components thereof, such as different formats, thresholds, number of phases, size of one or more phases, etc., to perform the MAC operation for the floating point numbers with reduced computation resources and power consumption and improved accuracy. Further, it should be noted that more or less components and/or different arrangements of the one or more components can be implemented to perform the features, operations, or procedures discussed herein.

The difference circuit 110 is an electronic circuit, e.g., an IC, including one or more logic gates B1, each configured to receive the local sums LS[1]-LS[N] from the phasing circuit 122. The one or more logic gates B1 may sometimes be referred to as a subtractor. In some cases, the one or more logic gates L1 or the one or more logic gates L2 can be a part of the difference circuit 110. The one or more logic gates B1 are configured to receive at least one of the maximum exponent sum MaxExp, as discussed below.

The one or more logic gates B1 are configured to, in operation, generate differences D[1]-D[N] by subtracting each data element of the local sums LS[1]-LS[N] from the maximum exponent sum MaxExp or the local maximum (for each of the N phases). For the first phasing method, the differences D[1]-D[N] can have the total number N and ordering of data elements corresponding to that of the exponent sums S[1]-S[N] and the products P[1]-P[N] discussed above. For the second phasing method, the differences D[1]-D[N] can have the total number N of data elements less than that of the exponent sums S[1]-S[N] and the products P[1]-P[N] discussed above because one or more pairs of exponent sums and products outside the N phases are removed. In this case, the differences D[1]-D[N] can have the total number N and ordering of data elements corresponding to that of the local sums LS[1]-LS[N] and the local products LP[1]-LP[N] from each of the N phases. In the embodiment depicted in FIG. 1, the one or more logic gates B1 are configured to output differences D[1]-D[N] to the shifting circuit 112 on one or more data buses (not shown).

In various arrangements, the operations of at least one of the summing circuits 108, the difference circuit 110, the selector circuit 111A, 111B, and/or the phasing circuit 122 can be performed before, after, or in parallel to the multiplier circuits 106. In some arrangements, one or more operations of the individual summing circuits 108, the difference circuit 110, the selector circuit 111A, 111B, and/or the phasing circuit 122 may be performed sequentially or in parallel, for example.

The shifting circuit 112 is an electronic circuit, e.g., an IC, including one or more registers and/or logic gates configured to perform a shifting operation on each instance LP[n] of the local products LP[1]-LP[N] from a respective phase based on the value of the corresponding instance D[n] of the differences D[1]-D[N] generated based on the corresponding local sums LS[1]-LS[N]. Each instance P[n] of the products P[1]-P[N] (or each instance LP[n] of the local products LP[1]-LP[N]) is based on the sign and mantissa of a corresponding combination of data elements InDE and WtDE, and each instance D[n] of the differences D[1]-D[N] is based on the sum of the exponents of the same combination. The shifting circuit 112 is configured to, in operation, right-shift each instance LP[n] of the local products LP[1]-LP[N] by an amount equal to the corresponding difference D[n] for the respective phase, thereby generating shifted products SP[1]-SP[N] in which sign and mantissa bits are aligned in accordance with the summed exponents used to generate the differences D[1]-D[N]. Based on this alignment, the shifting circuit 112 is configured to generate each instance SP[n] of the shifted products SP[1]-SP[N] having a same exponent using the maximum exponent sum MaxExp as a baseline for the N phases. In some cases, based on this alignment, the shifting circuit 112 is configured to generate each instance SP[n] of the shifted products SP[1]-SP[N] having a same exponent using the local maximum as a baseline for a respective phase of the N phases.

In some implementations, to compensate for the right-shifting operation, the shifting circuit 112 can add instances of the sign bit (zero or one) of each product P[n] (or local product LP[n]) as the leftmost bits of the corresponding shifted product SP[n]. The number of added instances of the sign bit is equal to the amount of the right shift as determined by the corresponding difference D[n].

In the illustrated embodiment of FIG. 1, the multiplier circuit 106 can generate the corresponding instance P[n] of the products P[1]-P[N] by performing the multiplying operation, as discussed above. The phasing circuit 122 can divide the products P[1]-P[N] into N phases with each phase including the respective local products LP[1]-LP[N] corresponding to the local sums LS[1]-LS[N]. The shifting circuit 112 can include one or more shifters to receive the local products LP[1]-LP[N] from the phasing circuit 122 in each of the N phases, and selectively output (e.g., shift) one or more of the shifted products SP[1]-SP[N] to the adder circuit 114 based on the respective differences D[1]-D[N]. For example in FIG. 1, the shifted products outputted to the adder circuit 114 may include SP[w]-SP[z], where “w” to “z” may each be one of the integers from 1 to N. In one aspect of the present disclosure, a sum of the number of SP[w]-SP[z] may be equal to N. In another aspect of the present disclosure, a sum of the number of SP[w]-SP[z] may be less than N.

The shifting circuit 112 can shift any of the local products LP[1]-LP[N] in each of the N phases, and output the shifted products SP[1]-SP[N] to the adder circuit 114 in response to the shift operation. As in the first phasing method, for example, the N phases can be associated with respective portions of the products P[1]-P[N]. As such, the sum of the number of SP[w]-SP[z] may be equal to N. In some configurations, the shifting circuit 112 may detect that at least one of the local products LP[1]-LP[N] from the phasing circuit 122 or at least one of the products P[1]-P[N] from the multiplier circuits 106 is zero. In such cases, the shifting circuit 112 may not perform a shift to the corresponding product with a value of zero and/or output the product to the adder circuit 114. As a result, the sum of the number of SP[w]-SP[z] may be less than N. In another example, a portion of the products P[1]-P[N] may be discarded (e.g., as part of the second phasing method) based on the corresponding exponent sums being outside the N phases. In such cases, the sum of the number of SP[w]-SP[z] may be less than N.

Further, to generate the SP[w]-SP[z], the shifting circuit 112 may right-shift each instance P[n] of the products P[w]-P[z] (or each instance LP[n] of the local products LP[1]-LP[N]) by an amount equal to a corresponding difference DA[n], thereby aligning sign and mantissa bits in accordance with the summed exponents. In some embodiments, the difference DA[n] may be generated (e.g., by the difference circuit 110) based on subtracting each data element of local sums LS[w]-LS[z] from a maximum exponent sum MaxExp or a local maximum of the respective phase. The maximum exponent sum MaxExp may correspond to a maximum value of the data elements of the sums S[w]-S[z]. The local maximum (e.g., LocalMax) can correspond to a maximum value of the data elements of the local sums LS[w]-LS[z] in a respective phase of the N phases. Based on this alignment, the shifting circuit 112 can generate each instance SP[n] of the shifted products SP[w]-SP[z] having a same exponent using the maximum exponent sum MaxExp or the local maximum as a baseline.

In some embodiments, e.g., those in which the data elements InDE and WtDE have the BF16 format, the shifting circuit 112 is configured to generate each of the shifted products, e.g., the SP[1]-SP[N], having a total of 21 bits based on each of the products P[1]-P[N] or the local products LP[1]-LP[N] having a total of 17 bits. In some embodiments, e.g., those in which the data elements InDE and WtDE have the FP16 format, the shifting circuit 112 is configured to generate each of the shifted products, e.g., the SP[1]-SP[N], having a total of 27 bits based on each of the products P[1]-P[N] or the local products LP[1]-LP[N] having a total of 23 bits. The shifting circuit 112 can be configured to generate each of the shifted products SP[1]-SP[N] having other total bit numbers based on each of the products P[1]-P[N] or the local products LP[1]-LP[N] having other total bit numbers is within the scope of the present disclosure.

Based on the products P[1]-P[N] having a two's complement format (thereby the local products LP[1]-LP[N] having the two's complement format), the shifting circuit 112 is configured to generate the shifted products, e.g., SP[1]-SP[N], having a two's complement format. As discussed above, in the illustrated example of FIG. 1, the shifting circuit 112 is configured to output the shifted products SP[w]-SP[z] to the adder circuit (tree) 114 on a data bus (not shown).

The adder tree 114 is an electronic circuit, e.g., an IC, including multiple layers of one or more logic gates (not shown), e.g., as discussed above with respect to one or more logic gates A1 (of the summing circuit 108). For example, the adder tree 114 may include a first layer configured to receive the shifted products SP[w]-SP[z], and a last layer configured to generate a sum 115 as a data element corresponding to a sum of the shifted products SP[w]-SP[z]. The adder tree 114 can generate the sum 115 for a respective phase of the N phases. For instance, the adder tree 114 can generate the sum 115 for the first phase at a first time period and another sum 115 for the second phase at a second time period, etc. In some embodiments, each of one or more successive layers between the first and last layers is configured to receive a first number of sum data elements generated by a preceding layer, and generate a second number of sum data elements based on the first number of sum data elements, the second number being half the first number. Thus, a total number of layers includes the first and last layers and each successive layer, if present.

The adder tree 114 can output the sum 115 for each of the N phases to an adder circuit 116 on one or more data buses (not shown). The adder circuit 116 is an electronic circuit, e.g., an IC, including multiple layers of one or more logic gates (not shown), e.g., as discussed above with respect to one or more logic gates A1 (of the summing circuit 108). The adder circuit 116 can be configured to perform similar operations as the adder tree 114, e.g., for adding multiple sums 115 of the shifted products SP[w]-SP[z] from different phases. For example, the adder circuit 116 may include or be electrically coupled with at least one memory array (not shown) configured to store the one or more sums 115 from the adder tree 114. The adder circuit 116 can receive the sum 115 from the adder tree 114 at a respective phase of the N phases, which can be stored in the memory array. The adder circuit 116 can include one or more other sums 115 from the adder tree 114 for the one or more remaining phases of the N phases. The adder circuit 116 can combine each of the sums 115 for the N phases to generate a combined result (e.g., which may represent the result of the shift and accumulation operation). In some cases, the adder circuit 116 may receive an indication of the number of phases from the phasing circuit 122.

In some implementations, the adder circuit 116 may include one or more components or features similar to the shifting circuit 112. For instance, the adder circuit 116 may receive a number of sums 115, each aligned to a different exponent sum. In this example, the adder circuit 116 may perform a shift operation on the sums 115, such as to align the sums 115 to the maximum exponent sum MaxExp by right-shifting one or more sums 115, for example. In response to the alignment, the adder circuit 116 can combine the aligned sums to generate a combined sum. The adder circuit 116 can iteratively combine the sum 115 with other sums 115 according to the N phases and output the combined sum (e.g., the sum PSTC 115S) to the converter 118 on one or more data buses (not shown).

The sum PSTC 115S is sometimes referred to as partial sum PSTC or mantissa sum PSTC in some embodiments, having a total number of bits corresponding to the number of bits and number of data elements of the shifted products SP[w]-SP[z]. In some embodiments, the number of bits of sum PSTC 115S is equal to the number of bits of shifted products SP[w]-SP[z] plus a number of bits capable of representing the number of data elements of shifted products SP[w]-SP[z]. In some embodiments, the number of bits of sum PSTC 115S is equal to the number of bits of shifted products SP[w]-SP[z] plus four bits capable of representing 16 data elements of shifted products SP[w]-SP[z].

In some embodiments, e.g., those in which data elements InDE and WtDE have the BF16 format, the adder tree 114 is configured to generate the sum PSTC 115S having a total of 25 bits based on each of the shifted products SP[w]-SP[z] having a total of 21 bits. In some embodiments, e.g., those in which data elements InDE and WtDE have the FP16 format, the adder tree 114 is configured to generate the sum PSTC 115S having a total of 31 bits based on each of the shifted products SP[w]-SP[z] having a total of 27 bits. The adder tree 114 being configured to generate the sum PSTC 115S based on each of the shifted products SP[w]-SP[z] having other total bit numbers is within the scope of the present disclosure.

Based on the shifted products SP[w]-SP[z] having a two's complement format, the adder tree 114 is configured to generate the sum PSTC 115S having a two's complement format, in accordance with various embodiments of the present disclosure. As such, the adder tree 114 is configured to output the sum PSTC 115S to the converter 118 on a data bus (not shown). In some other embodiments, the adder tree 114 may output the sum PSTC 115S to a circuit (not shown) external to the circuit 100.

The converter 118 is an electronic circuit, e.g., an IC, including logic circuitry configured to, in operation, receive the sum PSTC 115S from the adder circuit 116 (or in some cases the adder tree 114), and convert the sum PSTC 115S from two's complement to a sum PSSM having a sign plus mantissa format. The converter 118 is configured to generate the sum PSSM having a same number of bits as that of the sum PSTC. In the embodiment depicted in FIG. 1, the converter 118 is configured to further output the sum PSSM to the converter 120 on a data bus (not shown). In some other embodiments, the converter 118 may output the sum PSSM to a circuit (not shown) external to the circuit 100.

The converter 120 is an electronic circuit, e.g., an IC, including logic circuitry configured to, in operation, receive the sum PSSM from the converter 118 and the maximum exponent sum MaxExp from the difference circuit 110 or the selector circuit 111A, and convert the sum PSSM from the sign plus mantissa format to a sum PS having an output format based on the sum PSSM and the MaxExp and different from the sign plus mantissa format, e.g., a floating point format as discussed above. In various embodiments of the present disclosure, the converter 120 can generate the sum PS configured to be compatible with a circuit (not shown) external to the circuit 100. For example, the converter 120 is configured to output the sum PS to a circuit (not shown) external to the circuit 100, e.g., a memory array or other instance of the circuit 100 as part of a convolutional neural network (CNN). In some arrangements, the converter 118 can be a part of the converter 120, or vice versa.

FIG. 2 illustrates a flow chart of an example process 200 of performing the MAC operation executed by the circuit 100 of FIG. 1, in accordance with some embodiments. The example process 200 can be performed by the circuit 100 or one or more components of the circuit 100. As such, the following embodiment of the process 200 can be described in conjunction with but not limited to at least FIG. 1. Further, the following embodiment of the process 200 can be described in conjunction with but not limited to at least one of FIGS. 5-11. The illustrated embodiment of the process 200 is provided as an example and does not limit the scope of the present disclosure. Therefore, it shall be understood that any of a variety of the operations of the process 200 may be omitted, re-sequenced, and/or added while remaining within the scope of the present disclosure.

The process 200 starts with operation 202 for detecting an exponent sum range, in accordance with various embodiments. The exponent sum range can correspond to a range between the largest/highest (maximum) exponent sum and the smallest/lowest (minimum) exponent sum of the exponent sums S[1]-S[N], for example. For example, the circuit 100 (e.g., the first selector circuit 111A) can select the largest one among the exponent sums S[1]-S[N] as (or to generate) the largest exponent sum. The circuit 100 (e.g., the second selector circuit 111B) can select the smallest one among the exponent sums S[1]-S[N] as (or to generate) the smallest exponent sum. The exponent sums S[1]-S[N] may be generated by the summing circuits 108. The exponent sums S[1]-S[N] can correspond to the respective products P[1]-P[N] (generated by the multiplier circuits 106) of the pairs of exponent sums and products (e.g., input pairs). The circuit 100 (e.g., the phasing circuit 122) can detect or determine the exponent sum range based on the difference between the largest exponent sum and the smallest exponent.

The process 200 continues to operation 204 for determining to divide the data of the MAC operation (e.g., MAC data including the exponent sums S[1]-S[N] and/or the corresponding products P[1]-P[N]) based on the exponent sum range. The circuit 100 (e.g., the phasing circuit 122) can determine to divide the exponent sums S[1]-S[N] (and the corresponding products P[1]-P[N]) into phases based on the exponent sum range satisfying a predetermined threshold. The exponent sum range satisfying the predetermined threshold can include the exponent sum range being greater than or equal to the predetermined threshold. For instance, the predetermined threshold can include a value that, if the exponent sum range is satisfied, may indicate excessive power consumption or resource consumption and/or potential inaccuracy when executing the MAC operation. In such cases, if the exponent sum range is at or above the predetermined threshold, the circuit 100 can determine to divide the data of the MAC operation into multiple phases (e.g., utilizing at least one of the phasing methods discussed herein) to minimize resource consumption, reduce power consumption, and increase accuracy of the MAC operation. In some implementations, the circuit 100 may not divide the data of the MAC operation into the phases if the exponent sum range is less than the predetermined threshold. For purposes of providing examples, the circuit 100 can determine to divide the data of the MAC operation as described herein.

The process 200 continues to operation 206 for selecting the first phasing method or the second phasing method in response to the determination to divide the data of the MAC operation. The operation 206 can be described in conjunction with but not limited to at least one of FIG. 1 or 3. For example, FIG. 3 illustrates a flow chart of an example process (e.g., associated with operation 206) of selecting a (phasing) method for dividing exponent sums into a number of phases for the MAC operation of FIG. 2, in accordance with some embodiments. The example process of operation 206 can be performed by the circuit 100 or one or more components of the circuit 100, among other components or circuits, not limited to those in FIG. 1.

The process of operation 206 can include or start with operation 302 for receiving a difference threshold. The circuit 100 can receive or be configured with the difference threshold. The difference threshold can include a predetermined value representing an upper limit of a difference between the maximum exponent sum and the minimum exponent sum, indicating whether a portion of the MAC data is to be ignored or discarded (e.g., utilizing the second phasing method), as described herein.

The process of operation 206 continues to operation 304 for comparing the difference between a maximum value (e.g., maximum exponent sum) and a minimum value (e.g., minimum exponent sum) to the difference threshold. The difference may correspond to the exponent sum range. The process of operation 206 continues to operation 306 for determining whether the difference is greater than or equal to the difference threshold. For example, the circuit 100 (e.g., the phasing circuit 122) can compare the difference between the maximum value and the minimum value to the difference threshold.

If the difference is greater than or equal to the difference threshold, the circuit 100 can determine to proceed to operation 308 for selecting the second phasing method to be used for dividing the MAC data (e.g., the exponent sums S[1]-S[N] and the products P[1]-P[N]) into N phases. By using the second phasing method, the circuit 100 (e.g., the phasing circuit 122) can divide at least a portion of the MAC data into the N phases and discard other portions of the MAC data outside the N phases.

If the difference is less than the difference threshold, the circuit 100 can determine to proceed to operation 308 for selecting either the first phasing method or the second phasing method to be used for dividing the MAC data into N phases. At operation 310, the circuit 100 may be configured such that the first phasing method is selected if the difference is less than the difference threshold. By using the first phasing method, the circuit 100 (e.g., the phasing circuit 122) can divide all of the MAC data into the N phases, such that all data elements of the exponent sums S[1]-S[N] and the corresponding products P[1]-P[N] are considered during the MAC operation. In some configurations, the circuit 100 (e.g., phasing circuit 122) may be configured to utilize the second phasing method regardless of the difference. In such cases, operation 206 may not be performed, and the process 200 can proceed to operation 210, for example.

Referring back to FIG. 2, the process 200 continues to operation 208 or operation 210 based on whether the first phasing method or the second phasing method is selected. For example, in response to selecting the first phasing method, the process 200 continues to operation 208. In response to selecting the second phasing method, the process 200 continues to operation 210.

At operation 208, the circuit 100 (e.g., the phasing circuit 122) can divide the exponent sums S[1]-S[N] into N phases using the first phasing method. It should be noted that dividing the exponent sums S[1]-S[N] may include dividing the corresponding products P[1]-P[N] (e.g., applied similarly to the corresponding products P[1]-P[N]), such that any arrangement of the exponent sums S[1]-S[N] is similarly reflected on the corresponding products P[1]-P[N], for example. For example, the circuit 100 can receive or determine the exponent sum range. The circuit 100 can divide the exponent sums S[1]-S[N] into N (a number of) phases based on the exponent sum range, where each phase of the N phases is associated with a respective exponent subset of N exponent subsets. Each exponent subset can include respective one or more exponent sums of the exponent sums S[1]-S[N]. Each phase is associated with a respective mantissa (product) subset of N mantissa subsets, including respective one or more products of the products P[1]-P[N]. Each mantissa subset can correspond to a respective exponent subset.

For example, the N phases can correspond to or be a predetermined/predefined number of phases. Using the first phasing method, the circuit 100 may determine the size of each phase based on the exponent sum range divided by the predetermined number of phases. The circuit 100 can divide the exponent sums S[1]-S[N] into one or more of the N phases evenly sectioned between the minimum exponent sum and the maximum exponent sum.

In some implementations, each of the N phases can include a respective phase size based on the distribution of the exponent sums S[1]-S[N]. For example, a range of exponent sums (e.g., including one or more exponent sums) with relatively higher numbers (e.g., concentration or cluster) of data points (or a relatively higher repetition of certain exponent sums) may be divided into at least one phase having a relatively smaller phase size, e.g., to reduce power consumption or avoid reserving more bits for accumulation. For instance, a range of exponent sums with relatively fewer numbers of data points (or a relatively lower repetition of certain exponent sums) may be divided into at least one phase having a relatively larger phase size. Alternatively, in some embodiments, the number of phases may be based on the distribution of the exponent sums S[1]-S[N], such as described hereinabove. In response to dividing the exponent sums S[1]-S[N] (and the products P[1]-P[N]) into the N phases, the circuit 100 (e.g., difference circuit 110) can compute the exponent sum differences D[1]-D[N] based on the exponent sums S[1]-S[N] and one of the maximum exponent sum MaxExp or the local maximum (LocalMax).

At operation 210, the circuit 100 (e.g., the phasing circuit 122) can divide at least a portion of the exponent sums S[1]-S[N] (and the products P[1]-P[N]) into N phases using the second phasing method. Each of the N phases can include or be associated with a respective exponent subset of N exponent subsets and a corresponding mantissa subset of N mantissa subsets. Each exponent subset includes or corresponds to at least one exponent sum S[n] of the exponent sums S[1]-S[N]. Each mantissa subset includes or corresponds to at least one product P[n] of the products P[1]-P[N].

For example, using the second phasing method, the circuit 100 can divide at least the portion of the exponent sums S[1]-S[N] into N phases starting from the largest exponent sum. The N phases can correspond to N constant steps that are within the exponent sum range, e.g., the range of the N constant steps is less than or equal to the exponent sum range. The N constant steps can have a predefined step size. Each constant step can indicate different exponent sums (e.g., different magnitudes) to group into a phase. For example, the circuit 100 can group a first portion of the exponent sums S[1]-S[N] within a first constant step starting from the largest exponent sum (e.g., maximum exponent sum MaxExp) into a first phase. The circuit 100 can group a second portion of the exponent sums S[1]-S[N] within a second constant step continuing from the first constant step into a second phase. The circuit 100 can group other portions of the exponent sums S[1]-S[N] based on the N constant steps and/or the N phases. As such, the first phase can include one or more largest exponent sums, the second phase can include one or more second largest exponent sums, etc.

In response to dividing the portion of the exponent sums S[1]-S[N] (and the corresponding products P[1]-P[N]) into the N phases using the constant steps having the step size, at least one other portion of the exponent sums S[1]-S[N] (and the corresponding products P[1]-P[N]) may not be grouped into any of the N phases. In this case, the one other portion not grouped into the N phases includes one or more exponent sums having the largest difference from the maximum exponent sum. In other words, the circuit 100 may determine that the one other portion comprises one or more exponent sums and one or more corresponding products that, when used as part of the MAC operation, would be negligible or provide/yield minimal (or no) impact to the result of the MAC operation, e.g., potentially increasing the power consumption or resource consumption. In this example, and continuing to operation 212, the circuit 100 is configured to discard or ignore the data elements of the one other portion of the MAC data (e.g., the exponent sums S[1]-S[N] and the corresponding products P[1]-P[N]) with relatively large difference from the maximum exponent sum (e.g., or that are outside the N phases), as part of the second phasing method.

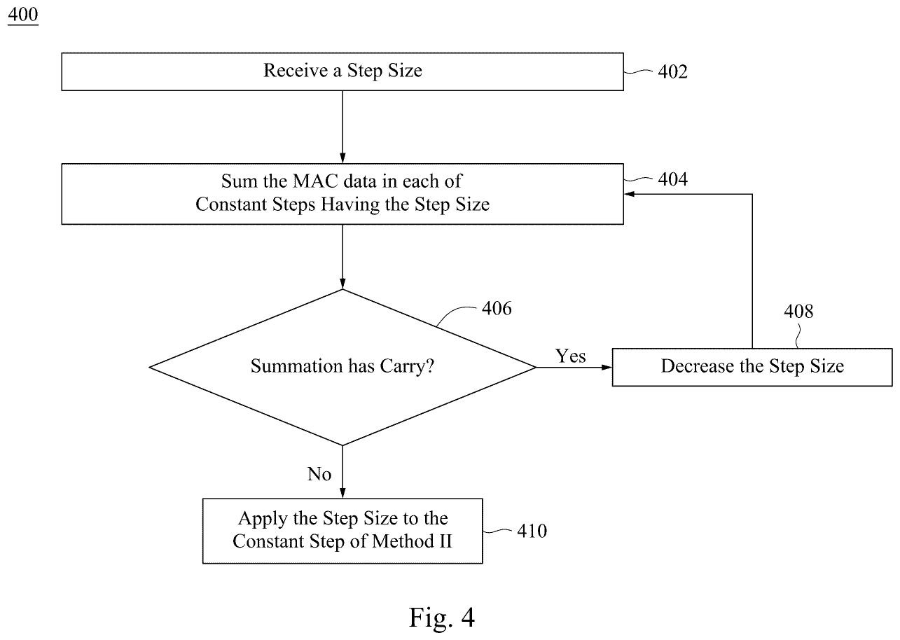

In some implementations, the circuit 100 (e.g., the phasing circuit 122) may receive an updated step size. The circuit 100 can update the step size of the constant steps to modify the phasing of the at least the exponent sums S[1]-S[N]. In some other implementations, the circuit 100 (e.g., the phasing circuit 122) may determine to adjust the step size, such as described in conjunction with at least FIG. 4.

For example, FIG. 4 illustrates a flow chart of an example process 400 of adjusting a step size for the MAC operation of FIG. 2, in accordance with some embodiments. The process 400 can be a part of one or more operations of process 200, such as a part of operation 210. The process 400 starts at operation 402 for receiving a step size or determining a preset (or predefined) step size. The step size can be a default step size predefined according to the configuration or specification of the circuit 100, for example. The process 400 continues to operation 404 for summing the MAC data in each of the constant steps having the step size.

The process 400 continues to operation 406 for determining whether the summation result has a carry. If the summation has a carry, the process 400 proceeds to operation 408 for decreasing the step size, and loops to operation 404. The operations 404, 406, and 408 can be repeated until the result of the summation does not have a carry. If the summation does not have a carry, the process 400 continues to operation 410 for applying the step size (e.g., the received step size or the adjusted (or decreased) step size) to the constant step for the second phasing method, e.g., setting the preset step size as a step size to apply to the constant step.

In some implementations, to divide (or prior to dividing) at least the portion of the exponent sums S[1]-S[N] into the N phases, the circuit 100 (e.g., the phasing circuit 122 or other components) can arrange or sort the exponent sums S[1]-S[N] based on the magnitudes of the exponent sums S[1]-S[N]. For instance, the circuit 100 can sort the exponent sums S[1]-S[N] from a largest exponent sum to a smallest exponent sum, or vice versa. The phasing or grouping of the MAC data can be performed on the sorted list of exponent sums S[1]-S[N]. The circuit 100 can align the corresponding products P[1]-P[N] to the exponent sums S[1]-S[N].

After dividing the exponent sums S[1]-S[N] into the N phases, the circuit 100 (e.g., the difference circuit 110) can compute or calculate N exponent differences for each of the N phases. Each of the N exponent differences can be equal to a difference between a corresponding one of the exponent sums S[1]-S[N] (e.g. local sums LS[1]-LS[N]) from the respective exponent subset of a particular phase and the largest exponent sum (e.g., maximum exponent sum MaxExp). The exponent differences can be used for the shift and accumulation operation. As described herein, each of the N exponent differences can be equal to a difference between a corresponding one of the local sums LS[1]-LS[N] from the respective exponent subset of a particular phase and the local maximum of the particular phase. The smallest exponent sum can be associated with the largest exponent difference of the N exponent differences. The largest exponent sum can be associated with a smallest exponent difference of the N exponent differences (e.g., a difference of zero compared to the maximum exponent sum).

In some implementations, the circuit 100 (e.g., the phasing circuit 122) is configured to determine a local maximum of the respective exponent subset in each of the N phases by selecting the largest one of the exponent sums in the respective phase. In this case, each of the N exponent differences can be equal to a difference between the corresponding one of the N exponent sums from the respective exponent subset and the local maximum of the respective exponent subset.

The process 200 continues to operation 214 (e.g., from operation 208 or operation 212) for performing the shift and accumulation operation. The shifting is performed for one or more products of the mantissa subset in each of the N phases using the corresponding one or more exponent sums of the exponent subset. The accumulation is performed for the partial sums from summing the shifted product(s) in each phase.

For example, the circuit 100 (e.g., the shifting circuit 112) can perform the shift operation to shift the local products LP[1]-LP[N] of the respective mantissa subset based on the corresponding exponent differences for each phase. As an example, the respective mantissa subset can include at least a first mantissa subset and a second mantissa subset of the products P[1]-P[N] for a first phase and a second phase of the N phases, respectively. Each of the mantissa subsets is associated with one or more local products LP[1]-LP[N] of a particular phase. The data elements of the local products LP[1]-LP[N] and the corresponding differences D[1]-D[N] can be provided from the phasing circuit 122 to the shifting circuit 112 in different time periods or time instances.

After shifting the local products LP[1]-LP[N] (e.g., shifted mantissa subset), the circuit 100 (e.g., the adder tree 114 or a first adder circuit) can sum the shifted (mantissa) products for each respective phase. For example, the circuit 100 (e.g., the shifting circuit 112) can generate a shifted first mantissa subset comprising shifted products SP[1]-SP[N] in the first phase at a first time period. The circuit 100 can generate a shifted second mantissa subset comprising shifted products SP[1]-SP[N] in the second phase, at a second time period. The circuit 100 can sum the shifted products SP[1]-SP[N] of the shifted first mantissa subset together in the first phase at the first time period, e.g., to generate a first sum. The circuit 100 can sum the shifted products SP[1]-SP[N] of the shifted second mantissa subset together in the second phase at the second time period, e.g., to generate a second sum. The circuit 100 can sum other shifted products SP[1]-SP[N] for the remainder of N phases, for example.

After summing the shifted products SP[1]-SP[N] for the N phases, the circuit 100 (e.g., the adder circuit 116 or a second adder circuit) can accumulate or combine the sums associated with the N phases. For example, the circuit 100 can combine the first sum and the second sum, among other sums associated with the N phases, to generate a result (e.g., combined sum or the sum PSTC 115S) of the shift and accumulation operation. It should be noted that the operations of the process 200 are provided as examples, and are not intended to limit the features or functionalities of the process 200. Further, it should be noted that more or less operations may be implemented for the process 200, for instance, to perform the MAC operation.

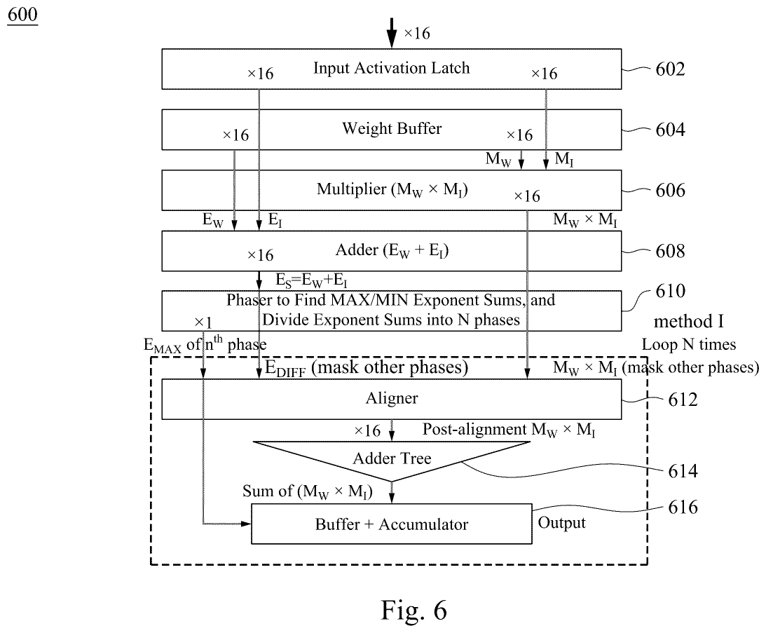

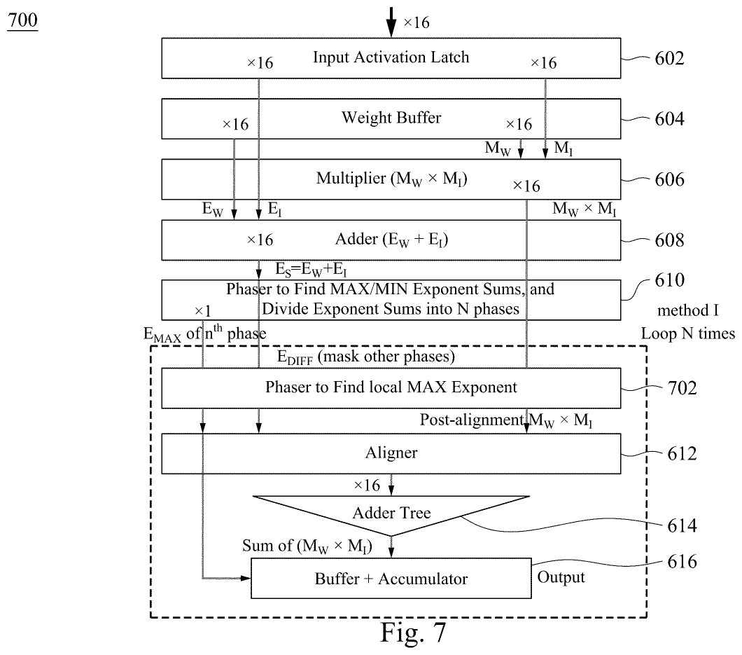

FIG. 5 is a graph 500 of an example distribution and grouping of the exponent sums using the first phasing method (e.g., method I) executed by the circuit 100 of FIG. 1, in accordance with some embodiments. The graph 500 illustrates an example exponent sum range (e.g., from the minimum exponent sum MinExp to the maximum exponent sum MaxExp) in the x-axis. The graph 500 illustrates an example probability of the distribution of the exponent sums (e.g., exponent sums S[1]-S[N]) across the exponent sum range in the y-axis. In this case, for example, there may be relatively more exponent sums (or more repetitions, groups, or clusters of similar exponent sums) received from the input circuit 104 or the memory circuit 102 that are around the median of the exponent sum range. Using the first phasing method, the circuit 100 can divide the exponent sums within the exponent sum range into N phases. For purposes of providing examples, the N phases can include four phases 502A-D as shown in FIG. 5, although other numbers of phases may be implemented. The division of the exponent sums into the phases and the utilization of the data in the phases with the first phasing method can be described in conjunction with but not limited to at least one of FIGS. 6 and 7.

FIG. 6 illustrates a flow chart of an example process 600 of performing the MAC operation using the first phasing method executed by the circuit 100 of FIG. 1, in accordance with some embodiments. The components or operations of the example process 600 can correspond to or be a part of the circuit 100. For example, one or more components of the example process 600 can include or correspond to at least a part of the circuit 100. The one or more operations of the one or more components of the example process 600 can be described in conjunction with at least one of FIGS. 1-3, among others, for example.

For example, the process 600 includes at least one input activation latch 602, at least one weight buffer 604, at least one multiplier 606, at least one adder 608, at least one circuit at least one aligner 612, at least one adder tree 614, and at least one buffer and accumulator 616. The input activation latch 602 and the weight buffer 604 can correspond to or perform operations similar to the input circuit 104, for instance, to provide the input data elements InDE and the weight data elements WtDE to one or more circuits or components of the circuit 100. Each input data element InDE and a corresponding weight data element WtDE can correspond to a pair of data elements (or a pair of input) of a plurality of pairs. Although FIG. 6 shows 16 input data elements InDE and 16 weight data elements WtDE, other numbers of data elements can be included as part of the MAC operation.

The multiplier 606 can correspond to or perform operations similar to at least one of the multiplier circuits 106. The multiplier 606 can receive the sign portion and the mantissa portion of the input data elements InDE and the weight data elements WtDE. For instance, the multiplier 606 can multiply a first mantissa (of the input data element InDE) and a second mantissa (of the weight data element WtDE) in a respective pair of inputs to generate one of N (mantissa) products (e.g., products P[n]). The multiplier 606 can multiply other pairs of mantissas (and the sign portion) to generate the N products (e.g., the products P[1]-P[N]).

The adder 608 can correspond to or perform operations similar to at least one of the summing circuit 108. The adder 608 can receive the exponent portion of the input data elements InDE and the weight data elements WtDE. For instance, the adder 608 can sum a first exponent (of the input data element InDE) and a second exponent (of the weight data element WtDE) in a respective pair of inputs to generate one of N exponent sums (e.g., exponent sum S[n]). The adder 608 can sum other pairs of exponents to generate the N exponent sums (e.g., the exponent sums S[1]-S[N]).

The phaser 610 can correspond to or perform operations similar to the phasing circuit 122. For example, the phaser 610 can identify, find, or receive (e.g., from the selector circuits 111) the maximum exponent sum (e.g., MaxExp) and the minimum exponent sum (e.g., MinExp). The phaser 610 can determine the exponent sum range based on the difference between the maximum exponent sum and the minimum exponent sum, such as shown in FIG. 5. Utilizing the first phasing method, the phaser 610 can divide the exponent sum range into N phases (e.g., four phases 502A-D). For purposes of providing examples, and referring to FIG. 5, the phaser 610 can divide the exponent sums within the exponent sum range into four phases 502A-D having a similar phase size. As shown, there may be seven exponent sums within the range of exponent sums, as an example. Each of the four phases 502A-D can include a respective range of exponent sums in which the phaser 610 is configured to determine which of the phases each exponent sum belongs to.

For example, the phaser 610 can divide the first and second largest exponent sums into the first phase 502A. The phaser 610 can divide the third and fourth largest exponent sums into the second phase 502B. The phaser 610 can divide the fifth and sixth largest exponent sums into the second phase 502B. The phaser 610 can divide the seventh largest exponent sum into the second phase 502B (in this case, the smallest exponent sum). It should be noted that the graph 500 illustrates the exponent sums sorted from smallest/minimum to largest/maximum. The one or more exponent sums in each phase may be referred to as or a part of an exponent subset (e.g., a subset of the exponent sums that has been divided into a respective phase). In some implementations, the phaser 610 can provide the exponent sums of the exponent subset to at least one subtractor (e.g., the difference circuit 110) to obtain one or more exponent differences between each of the exponent sums and the maximum exponent sum for aligning the corresponding mantissa products.

The aligner 612 can correspond to or perform operations similar to the shifting circuit 112. For example, the aligner 612 can receive one or more products from the phaser 610 a respective one of the four phases 502A-D. The products can be the local products for the respective phase. The aligner 612 can receive the exponent differences corresponding to the products for the respective phase. In this example, the aligner 612 can perform a shift operation to align the products to the maximum exponent sum, e.g., the alignment of the product is based on the corresponding exponent sum position. The aligner 612 can generate or output one or more shifted products for the respective phase.

The adder tree 614 can correspond to or perform operations similar to the adder tree 114. For example, the adder tree 614 can receive the shifted products for each of the phases from the aligner 612. The adder tree 614 can sum the shifted products between each other to generate a sum (e.g., product sum) for the respective phase.

The buffer and accumulator 616 can correspond to or perform operations similar to the adder circuit 116. For instance, the buffer and accumulator 616 can receive a first sum from the adder tree 614 in a first phase and store the first sum in a buffer. The buffer and accumulator 616 can receive a second sum from the adder tree 614 in a second phase and store the second sum in the buffer. The buffer and accumulator 616 can accumulate, sum, or combine the sums associated with the respective phases. The aligner 612, the adder tree 614, and the buffer and accumulator 616 can reiterate the operation for the N phases. The buffer and accumulator 616 can output the combined sums for the N phases as a result of the shift and accumulation operation (or the MAC operation).

In some implementations, the aligner 612 may shift the products based on the local maximum of each of the N phases, such as described in conjunction with at least FIG. 7. FIG. 7 illustrates a flow chart of an example process 700 of performing the MAC operation using the first phasing method with local maximum executed by the circuit 100 of FIG. 1, in accordance with some embodiments. The process 700 can include various operations or components similar to the process 600, e.g., the input activation latch 602, the weight buffer 604, the multiplier 606, the adder 608, the phaser 610, the aligner 612, the adder tree 614, and the buffer and accumulator 616. The process 700 may include other components from the circuit 100, not limited to those described herein.

In this case, the process 700 can include at least one phaser 702 to find the local maximum exponent (e.g., maximum exponent sum local to the respective phase). The phaser 702 may be a part of the phaser 610. For example, and as described in conjunction with FIG. 5, the phaser 702 can select the largest one of the exponent sums in each of the phases as the respective local maximum. The maximum exponent sum can be the local maximum for the first phase 502A. In such cases, the exponent differences can be a difference between each (local) exponent sum and the local maximum of the respective phase. The aligner 612 can align the products using the exponent difference determined according to the local maximum.

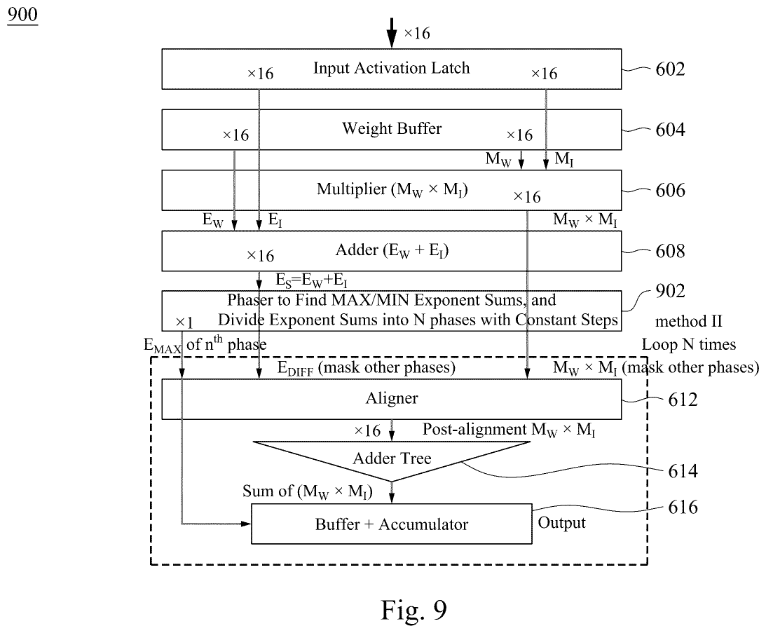

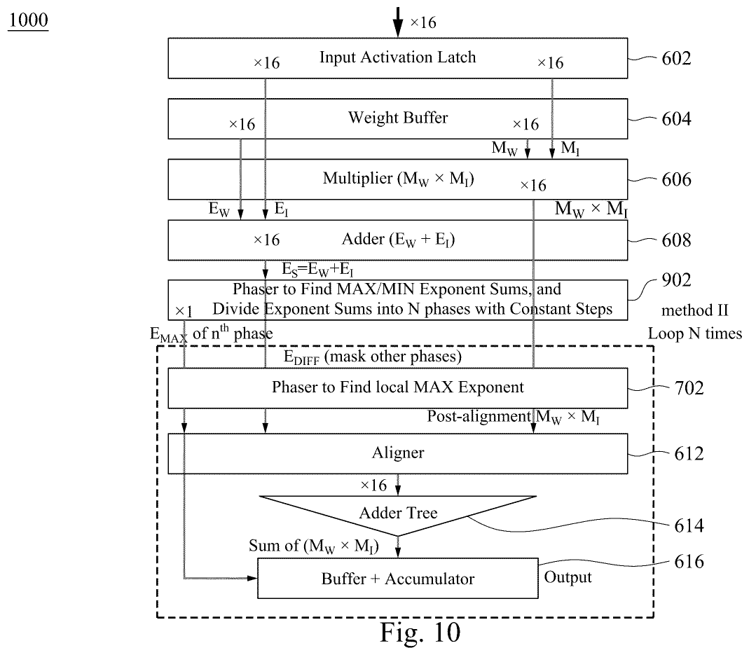

FIG. 8 is a graph 800 of an example distribution and grouping of the exponent sums using a second phasing method (e.g., method II) executed by the circuit 100 of FIG. 1, in accordance with some embodiments. The graph 800 illustrates an example exponent sum range in the x-axis and an example probability of the distribution of the exponent sums in the y-axis, similar to FIG. 5. The graph 800 can include one or more features similar to graph 500 of FIG. 5. Using the second phasing method, the circuit 100 can divide the exponent sums within the exponent sum range into N phases associated with N constant steps. For purposes of providing examples, the N phases can include three phases 802A-C associated with three constant steps, as shown in FIG. 8, although other numbers of phases may be implemented. The division of the exponent sums into the phases and the utilization of the data in the phases with the second phasing method can be described in conjunction with but not limited to at least one of FIGS. 9 and 10.

FIG. 9 illustrates a flow chart of an example process 900 of performing the MAC operation using the second phasing method executed by the circuit 100 of FIG. 1, in accordance with some embodiments. The process 900 can include various operations or components similar to at least one of processes 600 or 700 of FIG. 6 or 7, e.g., the input activation latch 602, the weight buffer 604, the multiplier 606, the adder 608, the aligner 612, the adder tree 614, and the buffer and accumulator 616. In this case, at least one phaser 902 can be used to perform the second phasing method. The process 900 may include other components from the circuit 100, not limited to those described herein.

The phaser 902 can correspond to or perform operations similar to the phasing circuit 122 (or phaser 610), for example. Using the second phasing method, the phaser 902 can find the maximum exponent sum corresponding to the largest one of the exponent sums. The phaser 902 can divide the exponent sums (from the adder 608) into the N phases with constant steps. The constant steps can include a predefined step size. In some cases, the step size may be adjusted or updated. The constant steps may start from the largest/maximum exponent sum for dividing the exponent sums into the associated N phases.

For example, there are three constant steps shown in FIG. 8 which correspond to the three phases 802A-C. The phaser 902 can divide the first and second exponent sums into the first phase with a first constant step starting from the maximum exponent sum. The phaser 902 can divide the third and fourth exponent sums into the second phase with a second constant step continuing from the first constant step. The phaser 902 can divide the fifth and sixth exponent sums into the third phase with a third constant step continuing from the second constant step. It should be noted that other number of constant steps may be used not limited to three constant steps. In this example, one or more exponent sums outside the range of the three phases 802A-C (or the three constant steps) (e.g., not divided into any phase or having relatively large differences from the maximum exponent sum) may be ignored or discarded from the MAC operation. As such, the phaser 902 can provide a portion of the exponent sums in the three phases 802A-C to perform the shift and accumulation of the corresponding products without another portion of the exponent sums outside the three phases 802A-C, for example.

In some implementations, the aligner 612 may align the products of the mantissa subset in each phase according to the maximum exponent sum. In some other implementations, the aligner 612 may align the products of the mantissa subset in each phase according to the local maximum (e.g., largest exponent sum in the respective phase), such as described in conjunction with FIG. 10.

For example, FIG. 10 illustrates a flow chart of an example process 1000 of performing the MAC operation using the second phasing method with local maximum executed by the circuit 100 of FIG. 1, in accordance with some embodiments. The process 1000 can include various operations or components similar to at least one of the processes 600, 700, or 900, e.g., the input activation latch 602, the weight buffer 604, the multiplier 606, the adder 608, the phaser 702, the phaser 902, the aligner 612, the adder tree 614, and the buffer and accumulator 616. The process 1000 may include other components from the circuit 100, not limited to those described herein.

In this case, the process 1000 can include the at least one phaser 702, such as described in conjunction with at least FIG. 7, to find the local maximum exponent (e.g., maximum exponent sum local to the respective phase). The phaser 702 may be a part of the phaser 902, in this case. For example, and as described in conjunction with FIG. 9, the phaser 702 can select the largest one of the exponent sums in each of the phases as the respective local maximum. The maximum exponent sum can be the local maximum for the first phase 802A. In such cases, the exponent differences can be a difference between each (local) exponent sum and the local maximum of the respective phase. The aligner 612 can align the products using the exponent difference determined according to the local maximum.

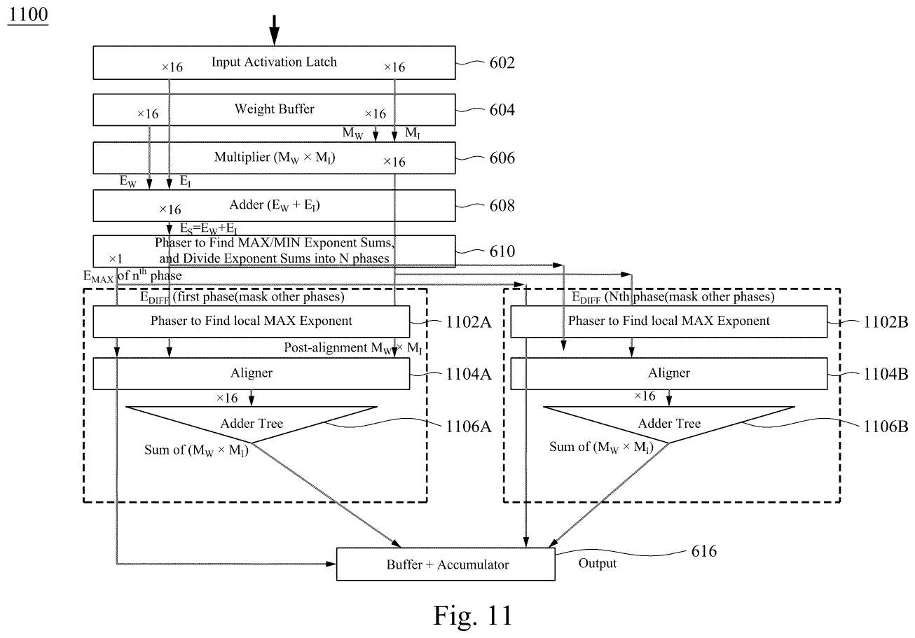

In some implementations, the circuit 100 can include N devices, components, or circuits (or N groups of devices) corresponding to the N phases, such that the alignment and summation can be performed in parallel. The circuit 100 including the N devices for the N phases can be described in conjunction with FIG. 11. For example, FIG. 11 illustrates a flow chart of an example process 1100 of performing the MAC operation using a number of devices (e.g., N devices) for the number of phases (e.g., N phases) executed by the circuit 100 of FIG. 1, in accordance with some embodiments. The process 1100 can include various operations or components similar but not limited to at least one of processes 600, 700, 900, or 1000 of at least one of FIG. 6, 7, 9, or 10, e.g., the input activation latch 602, the weight buffer 604, the multiplier 606, the adder 608, the phaser 610, the aligner 612, the adder tree 614, the buffer and accumulator 616, etc. The process 900 may include other components from the circuit 100, not limited to those described herein.

For purposes of providing examples, the process 1100 can be performed for two phases, thereby including respective phasers 1102A-B, aligners 1104A-B, and adder trees 1106A-B associated with the two phasers. It should be noted that the N phases can include more than two phases, thereby including more of the components or circuits described herein. Each of the phasers 1102A-B, aligners 1104A-B, and adder trees 1106A-B can perform features or operations similar to the phaser 702, aligner 612, and adder tree 614, respectively.

Taking the first phasing method with alignment to the respective local maximum (e.g., similar to process 700) as an example, the phaser 610 can provide the respective exponent subset of the N phases to the phasers 1102A-B, respectively. Further, the phaser 610 can provide the respective mantissa (product) subset corresponding to the exponent subset of the N phases to the aligners 1104A-B, respectively. The phaser 1102A can determine or find the largest one of the exponent sums in the first phase, which corresponds to the maximum exponent sum. The exponent differences can be determined for the exponent subset using the maximum exponent sum (e.g., the local maximum in this case). The aligner 1104A can align or shift the products of the mantissa subset according to the exponent differences for the first phase. The adder tree 1106A can sum the shifted products to generate a first sum of the first phase (of the N phases) for the buffer and accumulator 616.

In further examples, the phaser 1102B can find the largest one of the exponent sums in the second phase. The exponent differences can be determined for the exponent subset using the local maximum. The aligner 1104B can align or shift the products of the mantissa subset according to the exponent differences for the second phase. The adder tree 1106B can sum the shifted products to generate a second sum of the second phase for the buffer and accumulator 616. In response to receiving the sums (e.g., the first sum and the second sum), the buffer and accumulator 616 (e.g., another adder circuit) can combine the sums of or associated with the two phases (e.g., the N phases) to generate the result of the shift and accumulation operation (or the MAC operation). Accordingly, the circuit 100, among other components discussed herein, can be configured to reduce the resource and power consumption during the execution of the MAC operation, and improve the accuracy of the result of the MAC operation.

In one aspect of the present disclosure, a computing-in-memory (CIM) circuit is disclosed. The CIM circuit includes an input circuit configured to receive: (i) a number (N) of first inputs, and (ii) N second inputs, wherein the first inputs consist of at least N first exponents and N first mantissas, and the second inputs consist of at least N second exponents and N second mantissas, and wherein each of the second inputs and a corresponding one of the N first inputs form one of N input pairs. The CIM circuit includes N summing circuits, each of the N summing circuits configured to combine the corresponding first exponent and the corresponding second exponent of a corresponding one of the N input pairs to generate a corresponding one of N exponent sums. The CIM circuit includes a first selector circuit configured to select a largest one among the N exponent sums as a largest exponent sum. The CIM circuit includes a phasing circuit configured to divide at least a portion of the N exponent sums into N phases from the largest exponent sum, each of the N phases associated with a respective exponent subset of N exponent subsets. The CIM circuit includes N subtractor circuits, each of the N subtractor circuits configured to calculate a corresponding one of N exponent differences for each of the N phases, each of the N exponent differences being equal to a difference between a corresponding one of the N exponent sums from the respective exponent subset and the largest exponent sum, wherein the N exponent differences is used for a shift and accumulation operation.

In another aspect of the present disclosure, a computing-in-memory (CIM) circuit is disclosed. The CIM circuit includes an input circuit configured to receive: (i) a number (N) of first inputs, and (ii) N second inputs, wherein the first inputs consist of at least N first exponents and N first mantissas, and the second inputs consist of at least N second exponents and N second mantissas, and wherein each of the second inputs and a corresponding one of the N first inputs form one of N input pairs. The CIM circuit includes N summing circuits, each of the N summing circuits configured to combine the corresponding first exponent and the corresponding second exponent of a corresponding one of the N input pairs to generate a corresponding one of N exponent sums. The CIM circuit includes a first selector circuit configured to select a largest one among the N exponent sums as a largest exponent sum. The CIM circuit includes a second selector circuit configured to select a smallest one among the N exponent sums as a smallest exponent sum. The CIM circuit includes a phasing circuit configured to: (i) determine an exponent sum range based on a difference between the largest exponent sum and the smallest exponent sum, and (ii) divide the N exponent sums into N phases based on the exponent sum range, each of the N phases associated with a respective exponent subset of N exponent subsets. The CIM circuit includes N subtractor circuits, each of the N subtractor circuits configured to calculate a corresponding one of N exponent differences for each of the N phases, each of the N exponent differences being equal to a difference between a corresponding one of the N exponent sums from the respective exponent subset and the largest exponent sum, wherein the N exponent differences is used for a shift and accumulation operation.

In yet another aspect of the present disclosure, a method is disclosed. The method includes receiving, by a computing-in-memory (CIM) circuit, (i) a number (N) of first inputs, and (ii) N second inputs, wherein the first inputs consist of at least N first exponents and N first mantissas, and the second inputs consist of at least N second exponents and N second mantissas, and wherein each of the second inputs and a corresponding one of the N first inputs form one of N input pairs. The method includes generating, by the CIM circuit, a corresponding one of N exponent sums based on combining the corresponding first exponent and the corresponding second exponent of a corresponding one of the N input pairs. The method includes generating, by the CIM circuit, a corresponding one of N mantissa products based on selectively multiplying the corresponding first mantissa by the corresponding second mantissa of the corresponding one of the N input pairs. The method includes selecting, by the CIM circuit, a largest one among the N exponent sums as a largest exponent sum. The method includes dividing, by the CIM circuit, at least a portion of the N exponent sums and at least a corresponding portion of the N mantissa products into N phases, each of the N phases associated with a respective exponent subset of N exponent subsets and a respective mantissa subset of N mantissa subsets. The method includes determining, by the CIM circuit, a corresponding one of N exponent differences for each of the N phases, each of the N exponent differences being equal to a difference between a corresponding one of the N exponent sums from the respective exponent subset and the largest exponent sum. The method includes shifting, by the CIM circuit, the respective mantissa subset based on the corresponding N exponent differences for each of the N phases. The method includes determining, by the CIM circuit, a corresponding one of N sums based on summing the respective shifted mantissa subset. The method includes combining, by the CIM circuit, the N sums to generate a sum result.

As used herein, the terms “about” and “approximately” generally indicates the value of a given quantity that can vary based on a particular technology node associated with the subject semiconductor device. Based on the particular technology node, the term “about” can indicate a value of a given quantity that varies within, for example, 10-30% of the value (e.g., +10%, ±20%, or ±30% of the value).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computing-in-memory (CIM) circuit, comprising:
an input circuit configured to receive: (i) a number (N) of first inputs, and (ii) N second inputs, wherein the first inputs consist of at least N first exponents and N first mantissas, and the second inputs consist of at least N second exponents and N second mantissas, and wherein each of the second inputs and a corresponding one of the N first inputs form one of N input pairs;
N summing circuits, each of the N summing circuits configured to combine the corresponding first exponent and the corresponding second exponent of a corresponding one of the N input pairs to generate a corresponding one of N exponent sums;
a first selector circuit configured to select a largest one among the N exponent sums as a largest exponent sum;
a phasing circuit configured to divide at least a portion of the N exponent sums into N phases from the largest exponent sum, each of the N phases associated with a respective exponent subset of N exponent subsets; and
N subtractor circuits, each of the N subtractor circuits configured to calculate a corresponding one of N exponent differences for each of the N phases, each of the N exponent differences being equal to a difference between a corresponding one of the N exponent sums from the respective exponent subset and the largest exponent sum, wherein the N exponent differences is used for a shift and accumulation operation.

2. The CIM circuit of claim 1, wherein the N phases are associated with N constant steps starting from the largest exponent sum, and wherein another portion of the N exponent sums outside the N phases are discarded.

3. The CIM circuit of claim 2, wherein the phasing circuit is configured to determine a local maximum of the respective exponent subset in each of the N phases, and wherein each of the N exponent differences is equal to a difference between the corresponding one of the N exponent sums from the respective exponent subset and the local maximum of the respective exponent subset.

4. The CIM circuit of claim 1, further comprising:
N multiplier circuits, each of the N multiplier circuits configured to selectively multiply the corresponding first mantissa by the corresponding second mantissa of the corresponding input pair, so as to generate a corresponding one of N mantissa products,
wherein the phasing circuit is configured to divide at least a portion of the N mantissa products that correspond to at least the portion of the N exponent sums into the N phases, wherein a respective mantissa subset of the N mantissa products and the corresponding exponent subset of each of the N phases is used for the shift and accumulation operation.

5. The CIM circuit of claim 4, further comprising:
a shifter circuit configured to shift the respective mantissa subset based on the corresponding N exponent differences for each of the N phases, the respective mantissa subset comprising at least a first mantissa subset and a second mantissa subset of the N mantissa products for a first phase and a second phase of the N phases, respectively.

6. The CIM circuit of claim 5, wherein the phasing circuit is configured to provide the first phase and the second phase to the shifter circuit at different time periods.

7. The CIM circuit of claim 5, further comprising:
a first adder circuit configured to: (i) sum the shifted first mantissa subset of the N mantissa products for the first phase so as to generate a first sum, and (ii) sum the shifted second mantissa subset of the N mantissa products for the second phase so as to generate a second sum.

8. The CIM circuit of claim 7, further comprising:
a second adder circuit configured to combine the first sum and the second sum of the N phases so as to generate a result of the shift and accumulation operation.

9. The CIM circuit of claim 1, wherein to divide at least the portion of the N exponent sums into the N phases, the phasing circuit is configured to:
sort the N exponent sums from the largest exponent sum to a smallest exponent sum, wherein the smallest exponent sum is associated with a largest exponent difference of the N exponent differences, and wherein the largest exponent sum is associated with a smallest exponent difference of the N exponent differences; and
divide at least the portion of the sorted N exponent sums into at least a first phase and a second phase of the N phases corresponding to a first constant step and a second constant step of N constant steps, respectively,
wherein the N constant steps have a predefined step size, wherein the first phase comprises first exponent sums within the first constant step starting from the largest exponent sum, and wherein the second phase comprises second exponent sums within the second constant step continuing from the first constant step.

10. The CIM circuit of claim 1, further comprising:
a second selector circuit configured to select a smallest one among the N exponent sums as a smallest exponent sum;
a second subtractor circuit configured to calculate a difference between the largest exponent sum and the smallest exponent sum so as to generate an exponent sum range,
wherein the phasing circuit is configured to:
compare the exponent sum range to a threshold; and
divide all of the N exponent sums into the N phases based on the exponent sum range being less than the threshold; or
divide at least the portion of the N exponent sums into the N phases based on the exponent sum range being greater than or equal to the threshold.

11. The CIM circuit of claim 1, further comprising:
N phasing circuits for the respective N phases, each of the N phasing circuits configured to determine a local maximum of the respective exponent subset for a corresponding one of the N phases, wherein each of the N exponent differences is equal to a difference between the corresponding one of the N exponent sums from the respective exponent subset and the local maximum of the respective exponent subset, and wherein the phasing circuit is one of the N phasing circuits;
N shifter circuits associated with the respective N phasing circuits, each of the N shifter circuits configured to shift a mantissa subset based on the corresponding N exponent differences for the corresponding one of the N phases;
N adder circuits associated with the respective N shifter circuits, each of the N adder circuits configured to sum the shifted mantissa subset for the corresponding one of the N phases so as to generate a corresponding one of N sums; and
another adder circuit configured to combine the N sums of the N phases so as to generate a result of the shift and accumulation operation.

12. A computing-in-memory (CIM) circuit, comprising:
an input circuit configured to receive: (i) a number (N) of first inputs, and (ii) N second inputs, wherein the first inputs consist of at least N first exponents and N first mantissas, and the second inputs consist of at least N second exponents and N second mantissas, and wherein each of the second inputs and a corresponding one of the N first inputs form one of N input pairs;
N summing circuits, each of the N summing circuits configured to combine the corresponding first exponent and the corresponding second exponent of a corresponding one of the N input pairs to generate a corresponding one of N exponent sums;
a first selector circuit configured to select a largest one among the N exponent sums as a largest exponent sum;
a second selector circuit configured to select a smallest one among the N exponent sums as a smallest exponent sum;
a phasing circuit configured to: (i) determine an exponent sum range based on a difference between the largest exponent sum and the smallest exponent sum, and (ii) divide the N exponent sums into N phases based on the exponent sum range, each of the N phases associated with a respective exponent subset of N exponent subsets; and
N subtractor circuits, each of the N subtractor circuits configured to calculate a corresponding one of N exponent differences for each of the N phases, each of the N exponent differences being equal to a difference between a corresponding one of the N exponent sums from the respective exponent subset and the largest exponent sum, wherein the N exponent differences is used for a shift and accumulation operation.

13. The CIM circuit of claim 12, wherein the phasing circuit is configured to determine a local maximum of the respective exponent subset in each of the N phases, and wherein each of the N exponent differences is equal to a difference between the corresponding one of the N exponent sums from the respective exponent subset and the local maximum of the respective exponent subset.

14. The CIM circuit of claim 12, further comprising:
N multiplier circuits, each of the N multiplier circuits configured to selectively multiply the corresponding first mantissa by the corresponding second mantissa of the corresponding input pair, so as to generate a corresponding one of N mantissa products,
wherein the phasing circuit is configured to divide the N mantissa products that correspond to the N exponent sums into the N phases, wherein a respective mantissa subset of the N mantissa products and the corresponding exponent subset of each of the N phases is used for the shift and accumulation operation.

15. The CIM circuit of claim 14, further comprising
a shifter circuit configured to shift the respective mantissa subset based on the corresponding N exponent differences for each of the N phases, the respective mantissa subset comprising at least a first mantissa subset and a second mantissa subset of the N mantissa products for a first phase and a second phase of the N phases, respectively;
a first adder circuit configured to: (i) sum the shifted first mantissa subset of the N mantissa products for the first phase so as to generate a first sum, and (ii) sum the shifted second mantissa subset of the N mantissa products for the second phase so as to generate a second sum; and
a second adder circuit configured to combine the first sum and the second sum of the N phases so as to generate a result of the shift and accumulation operation.

16. The CIM circuit of claim 15, wherein the phasing circuit is configured to provide the first phase and the second phase to the shifter circuit at different time periods, and wherein the first adder circuit is configured to sum the shifted first mantissa subset for the first phase and sum the shifted second mantissa subset for the second phase at the different time periods.

17. The CIM circuit of claim 12, wherein the N phases correspond to a predefined number, or wherein the N phases correspond to N constant steps that are within the exponent sum range, the N constant steps having a predefined step size.

18. A method, comprising:
receiving, by a computing-in-memory (CIM) circuit, (i) a number (N) of first inputs, and (ii) N second inputs, wherein the first inputs consist of at least N first exponents and N first mantissas, and the second inputs consist of at least N second exponents and N second mantissas, and wherein each of the second inputs and a corresponding one of the N first inputs form one of N input pairs;
generating, by the CIM circuit, a corresponding one of N exponent sums based on combining the corresponding first exponent and the corresponding second exponent of a corresponding one of the N input pairs;
generating, by the CIM circuit, a corresponding one of N mantissa products based on selectively multiplying the corresponding first mantissa by the corresponding second mantissa of the corresponding one of the N input pairs;
selecting, by the CIM circuit, a largest one among the N exponent sums as a largest exponent sum;
dividing, by the CIM circuit, at least a portion of the N exponent sums and at least a corresponding portion of the N mantissa products into N phases, each of the N phases associated with a respective exponent subset of N exponent subsets and a respective mantissa subset of N mantissa subsets;
determining, by the CIM circuit, a corresponding one of N exponent differences for each of the N phases, each of the N exponent differences being equal to a difference between a corresponding one of the N exponent sums from the respective exponent subset and the largest exponent sum;
shifting, by the CIM circuit, the respective mantissa subset based on the corresponding N exponent differences for each of the N phases;
determining, by the CIM circuit, a corresponding one of N sums based on summing the respective shifted mantissa subset; and
combining, by the CIM circuit, the N sums to generate a sum result.

19. The method of claim 18, further comprising:
selecting, by the CIM circuit, a largest one among the corresponding N exponent sums of the respective exponent subset as a respective local maximum,
wherein each of the N exponent differences is equal to a difference between the corresponding one of the N exponent sums from the respective exponent subset and the local maximum, and wherein the respective mantissa subset of each of the N phases is shifted and summed at a respective time period.

20. The method of claim 18, further comprising:
selecting, by the CIM circuit, a smallest one among the N exponent sums as a smallest exponent sum;
determining, by the CIM circuit, an exponent sum range based on a difference between the largest exponent sum and the smallest exponent sum;
comparing, by the CIM circuit, the exponent sum range to a threshold; and
in response to the comparison:
dividing, by the CIM circuit, all of the N exponent sums into the N phases based on the exponent sum range being less than the threshold, wherein the N phases correspond to a predefined number, or wherein the N phases correspond to N constant steps that are within the exponent sum range; or
dividing, by the CIM circuit, at least the portion of the N exponent sums into the N phases based on the exponent sum range being greater than or equal to the threshold, wherein the N phases are associated with N constant steps starting from the largest exponent sum.
